(19) United States
(12) Patent Application Publication
(10) Pub. No.: US 2014/0258194 A1
(43) Pub. Date: Sep. 11, 2014

(54) GENERIC METHOD FOR DESIGNING SPIKE-TIMING DEPENDENT PLASTICITY (STDP) CURVES

(71) Applicant: QUALCOMM Incorporated, San Diego, CA (US)

(72) Inventors: Regan Blythe TOWAL, San Diego, CA (US); Thomas Jiaqian ZHENG, San Diego, CA (US)

(73) Assignee: QUALCOMM Incorporated, San Diego, CA (US)

(21) Appl. No.: 14/081,023

(22) Filed: Nov. 15, 2013

Related U.S. Application Data
(60) Provisional application No. 61/775,192, filed on Mar. 8, 2013.
(60) Provisional application No. 61/862,729, filed on Aug. 6, 2013.

(51) Int. Cl. G06N 3/02

(52) U.S. Cl. CPC G06N 3/02
USPC 706/15; 706/25; 706/26

(57) ABSTRACT

Methods and apparatus are provided for designing spike-timing dependent plasticity (STDP) curves whose parameter values are based on a set of equations. One example method generally includes operating an artificial nervous system by determining a set of equations based at least in part on a form of an STDP function defined by one or more parameters, determining values of the parameters for the STDP function based at least in part on the set of equations, and operating at least a portion of the artificial nervous system according to the STDP function having the determined parameter values.

### CLAIM OF PRIORITY UNDER 35 U.S.C. §119

This application claims benefit of U.S. Provisional Patent Application Ser. No. 61/775,192, filed Mar. 8, 2013 and entitled “Generic Method for Designing Spike-Timing Dependent Plasticity (STDP) Curves,” and U.S. Provisional Patent Application Ser. No. 61/862,729, filed Aug. 6, 2013 and entitled “Generic Method for Designing Spike-Timing Dependent Plasticity (STDP) Curves,” each of which is herein incorporated by reference in its entirety.

### BACKGROUND

1. Field

Certain aspects of the present disclosure generally relate to artificial nervous systems and, more particularly, to designing spike-timing dependent plasticity (STDP) curves.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

One type of artificial neural network is the spiking neural network, which incorporates the concept of time into its operating model, as well as neuronal and synaptic state, thereby providing a rich set of behaviors from which computational function can emerge in the neural network. Spiking neural networks are based on the concept that neurons fire or “spike” at a particular time or times based on the state of the neuron, and that the time is important to neuron function. When a neuron fires, it generates a spike that travels to other neurons, which, in turn, may adjust their states based on the time this spike is received. In other words, information may be encoded in the relative or absolute timing of spikes in the neural network.

### SUMMARY

Certain aspects of the present disclosure generally relate to designing spike-timing dependent plasticity (STDP) curves whose parameter values are based on a set of equations, rather than on only a single equation representing the form of the STDP curve.

Certain aspects of the present disclosure provide a method for operating an artificial nervous system. The method generally includes determining a set of equations based at least in part on a form of an STDP function defined by one or more parameters, determining values of the parameters for the STDP function based at least in part on the set of equations, and operating at least a portion of the artificial nervous system according to the STDP function having the determined parameter values.

Certain aspects of the present disclosure provide an apparatus for operating an artificial nervous system. The apparatus generally includes a processing system and a memory coupled to the processing system. The processing system is typically configured to determine a set of equations based at least in part on a form of an STDP function defined by one or more parameters, to determine values of the parameters for the STDP function based at least in part on the set of equations, and to operate at least a portion of the artificial nervous system according to the STDP function having the determined parameter values.

Certain aspects of the present disclosure provide an apparatus for operating an artificial nervous system. The apparatus generally includes means for determining a set of equations based at least in part on a form of an STDP function defined by one or more parameters; means for determining values of the parameters for the STDP function based at least in part on the set of equations; and means for operating at least a portion of the artificial nervous system according to the STDP function having the determined parameter values.

Certain aspects of the present disclosure provide a computer program product for operating an artificial nervous system. The computer program product generally includes a computer-readable medium having instructions executable to determine a set of equations based at least in part on a form of an STDP function defined by one or more parameters, to determine values of the parameters for the STDP function based at least in part on the set of equations, and to operate at least a portion of the artificial nervous system according to the STDP function having the determined parameter values.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network of neurons in accordance with certain aspects of the present disclosure.

FIG. 2 illustrates an example processing unit (neuron) of a computational network (neural system or neural network), in accordance with certain aspects of the present disclosure.

FIG. 3 illustrates an example spike-timing dependent plasticity (STDP) curve in accordance with certain aspects of the present disclosure.

FIG. 4 is an example graph of state for an artificial neuron, illustrating a positive regime and a negative regime for defining behavior of the neuron, in accordance with certain aspects of the present disclosure.

FIG. 5 is a flow diagram for the overall design process, in accordance with certain aspects of the present disclosure.

FIGS. 6A-C illustrate an example network topology and canonical sub-networks, in accordance with certain aspects of the present disclosure.

FIG. 7 illustrates the excitation time constant (τ₋) effect on leaky-integrate-and-fire (LIF) integration properties, in accordance with certain aspects of the present disclosure.

FIG. 8 is a cumulative distribution function (CDF) for inter-event intervals, in accordance with certain aspects of the present disclosure.

FIG. 9 illustrates an inhibition time constant (τ₊) limiting case, in accordance with certain aspects of the present disclosure.

FIG. 10A is an example double exponential STDP curve, in accordance with certain aspects of the present disclosure.

FIG. 10B is an example probability density function (PDF) for a Beta distribution for implementing an STDP curve, in accordance with certain aspects of the present disclosure.

FIG. 11 illustrates an example limiting case for potentiation, in accordance with certain aspects of the present disclosure.

FIG. 12 illustrates an example limiting case for depression, in accordance with certain aspects of the present disclosure.

FIGS. 13A and 13B illustrate E[ΔW] as a function of k₊, in accordance with certain aspects of the present disclosure.

FIGS. 14A-C illustrate two different STDP rules, a histogram, and the STDP curves derived therefrom, in accordance with certain aspects of the present disclosure.

FIG. 15 illustrates example grating stimuli used to train the V1 magno pathway, in accordance with certain aspects of the present disclosure.

FIG. 16 is a table of feature extraction performance training with gratings, in accordance with certain aspects of the present disclosure.

FIG. 17 is an image of Building N on the Qualcomm campus, in accordance with certain aspects of the present disclosure.

FIG. 18 is a table of differences in retinal activity parameters affecting downstream neuron design, in accordance with certain aspects of the present disclosure.

FIGS. 19A and 19B illustrate parasol cell spiking during grating and building training for comparison, in accordance with certain aspects of the present disclosure.

FIGS. 20A and 20B illustrate magno layer 4 receptive fields under grating and building training for comparison, in accordance with certain aspects of the present disclosure.

FIGS. 21A and 21B illustrate weight changes with training time during Building N training, in accordance with certain aspects of the present disclosure.

FIGS. 22A-C illustrate calculating the expected features and expected feature gaps for Building N image of FIG. 17, in accordance with certain aspects of the present disclosure.

FIG. 23 is a table listing Cold model parameters for the grating and Building N images, in accordance with certain aspects of the present disclosure.

FIG. 24 is a table of feature extraction performance training on Building N, in accordance with certain aspects of the present disclosure.

FIG. 25 is a flow diagram of example operations for operating an artificial nervous system, in accordance with certain aspects of the present disclosure.

FIG. 25A illustrates example means capable of performing the operations shown in FIG. 25.

FIG. 26 illustrates an example implementation for operating an artificial nervous system using a general-purpose processor, in accordance with certain aspects of the present disclosure.

FIG. 27 illustrates an example implementation for operating an artificial nervous system where a memory may be interfaced with individual distributed processing units, in accordance with certain aspects of the present disclosure.

FIG. 28 illustrates an example implementation for operating an artificial nervous system based on distributed memories and distributed processing units, in accordance with certain aspects of the present disclosure.

FIG. 29 illustrates an example implementation of a neural network in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System

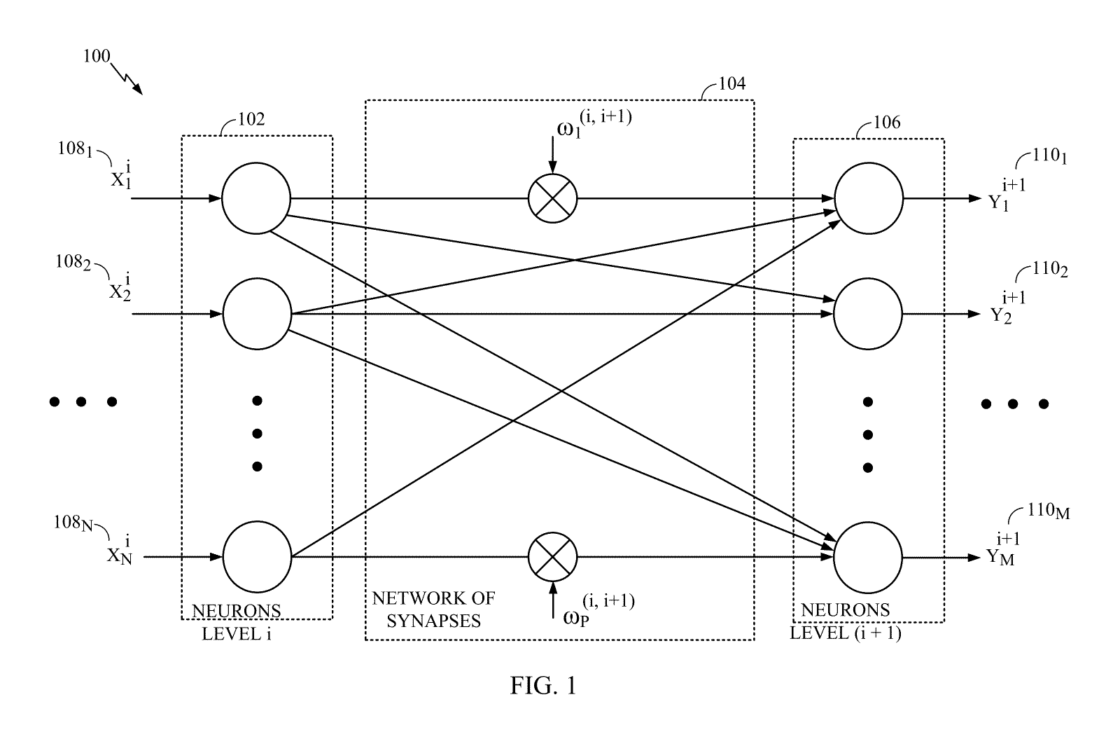

FIG. 1 illustrates an example neural system 100 with multiple levels of neurons in accordance with certain aspects of the present disclosure. The neural system 100 may comprise a level of neurons 102 connected to another level of neurons 106 though a network of synaptic connections 104 (i.e., feed-forward connections). For simplicity, only two levels of neurons are illustrated in FIG. 1, although fewer or more levels of neurons may exist in a typical neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by a plurality of neurons of a previous level (not shown in FIG. 1). The signal 108 may represent an input (e.g., an input current) to the level 102 neuron. Such inputs may be accumulated on the neuron membrane to charge a membrane potential. When the membrane potential reaches its threshold value, the neuron may fire and generate an output spike to be transferred to the next level of neurons (e.g., the level 106). Such behavior can be emulated or simulated in hardware and/or software, including analog and digital implementations.

In biological neurons, the output spike generated when a neuron fires is referred to as an action potential. This electrical signal is a relatively rapid, transient, all-or nothing nerve impulse, having an amplitude of roughly 100 mV and a duration of about 1 ms. In a particular aspect of a neural system having a series of connected neurons (e.g., the transfer of spikes from one level of neurons to another in FIG. 1), every action potential has basically the same amplitude and duration, and thus, the information in the signal is represented only by the frequency and number of spikes (or the time of spikes), not by the amplitude. The information carried by an action potential is determined by the spike, the neuron that spiked, and the time of the spike relative to one or more other spikes.

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons (pre-synaptic neurons relative to the synapses 104). For certain aspects, these signals may be scaled according to adjustable synaptic weights w₁^{(i,i+1)}, . . . , w_{P}^{(i,i+1)} (where P is a total number of synaptic connections between the neurons of levels 102 and 106). For other aspects, the synapses 104 may not apply any synaptic weights. Further, the (scaled) signals may be combined as an input signal of each neuron in the level 106 (post-synaptic neurons relative to the synapses 104). Every neuron in the level 106 may generate output spikes 110 based on the corresponding combined input signal. The output spikes 110 may be then transferred to another level of neurons using another network of synaptic connections (not shown in FIG. 1).

Biological synapses may be classified as either electrical or chemical. While electrical synapses are used primarily to send excitatory signals, chemical synapses can mediate either excitatory or inhibitory (hyperpolarizing) actions in postsynaptic neurons and can also serve to amplify neuronal signals. Excitatory signals typically depolarize the membrane potential (i.e., increase the membrane potential with respect to the resting potential). If enough excitatory signals are received within a certain period to depolarize the membrane potential above a threshold, an action potential occurs in the postsynaptic neuron. In contrast, inhibitory signals generally hyperpolarize (i.e., lower) the membrane potential Inhibitory signals, if strong enough, can counteract the sum of excitatory signals and prevent the membrane potential from reaching threshold. In addition to counteracting synaptic excitation, synaptic inhibition can exert powerful control over spontaneously active neurons. A spontaneously active neuron refers to a neuron that spikes without further input, for example, due to its dynamics or feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and the like. Each neuron (or neuron model) in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, wherein synaptic weight changes may relate to changes of the memristor resistance. With nanometer feature-sized memristors, the area of neuron circuit and synapses may be substantially reduced, which may make implementation of a very large-scale neural system hardware implementation practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, wherein a particular functionality may be based on synaptic weights stored in a memory card currently attached to the neural processor.

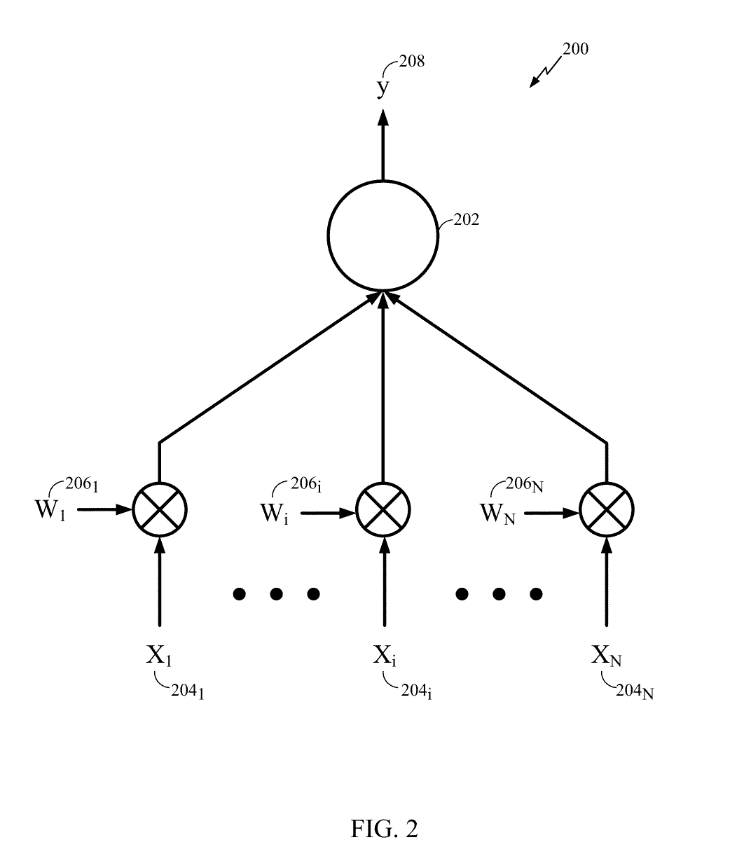

FIG. 2 illustrates an example 200 of a processing unit (e.g., an artificial neuron 202) of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (x₁-x_{N}), which may be signals external to the neural system, or signals generated by other neurons of the same neural system, or both. The input signal may be a current or a voltage, real-valued or complex-valued. The input signal may comprise a numerical value with a fixed-point or a floating-point representation. These input signals may be delivered to the neuron 202 through synaptic connections that scale the signals according to adjustable synaptic weights 206₁-206_{N} (w₁-w_{N}), where N may be a total number of input connections of the neuron 202.

The neuron 202 may combine the scaled input signals and use the combined scaled inputs to generate an output signal 208 (i.e., a signal y). The output signal 208 may be a current, or a voltage, real-valued or complex-valued. The output signal may comprise a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by wires with synaptic circuits. The processing unit 202, its input and output connections may also be emulated by a software code. The processing unit 202 may also be emulated by an electric circuit, whereas its input and output connections may be emulated by a software code. In an aspect, the processing unit 202 in the computational network may comprise an analog electrical circuit. In another aspect, the processing unit 202 may comprise a digital electrical circuit. In yet another aspect, the processing unit 202 may comprise a mixed-signal electrical circuit with both analog and digital components. The computational network may comprise processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Some examples of the learning rule are the spike-timing-dependent plasticity (STDP) learning rule, the Hebb rule, the Oja rule, the Bienenstock-Copper-Munro (BCM) rule, etc. Very often, the weights may settle to one of two values (i.e., a bimodal distribution of weights). This effect can be utilized to reduce the number of bits per synaptic weight, increase the speed of reading and writing from/to a memory storing the synaptic weights, and to reduce power consumption of the synaptic memory.

### Synapse Type

In hardware and software models of neural networks, processing of synapse related functions can be based on synaptic type. Synapse types may comprise non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not require plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) since structural plasticity (i.e., an amount of delay change) may be a direct function of pre-post spike time difference. Alternatively, it may be set as a function of the weight change amount or based on conditions relating to bounds of the weights or weight changes. For example, a synaptic delay may change only when a weight change occurs or if weights reach zero, but not if the weights are maxed out. However, it can be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as to computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity, and homeostatic plasticity.

STDP is a learning process that adjusts the strength of synaptic connections between neurons, such as those in the brain. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. In contrast, long-term depression (LTD) may occur if an input spike tends, on average, to occur immediately after an output spike. Then, that particular input is made somewhat weaker, hence the name “spike-timing-dependent plasticity.” Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to zero or near zero.

Since a neuron generally produces an output spike when many of its inputs occur within a brief period (i.e., being sufficiently cumulative to cause the output,), the subset of inputs that typically remains includes those that tended to be correlated in time. In addition, since the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₒₛₜ of the post-synaptic neuron (i.e., t=tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP process, a change of the synaptic weight over time may be typically achieved using an exponential decay, as given by,

$$Δ w ( t ) = \{ \begin{matrix}{a}_{+} {e}^{- t / {k}_{+}} + μ , t > 0 \\ {a\_e}^{t / k} , t < 0\end{matrix} , \qquad ( 1 )$$

where k₊ and k₋ are time constants for positive and negative time difference, respectively, a₊ and a₋ are corresponding scaling magnitudes, and μ is an offset that may be applied to the positive time difference and/or the negative time difference.

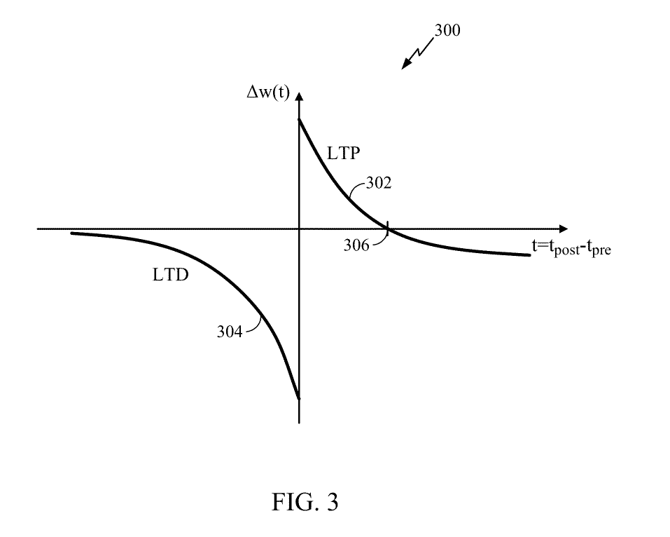

FIG. 3 illustrates an example graph diagram 300 of a synaptic weight change as a function of relative timing of pre-synaptic and post-synaptic spikes in accordance with STDP. If a pre-synaptic neuron fires before a post-synaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between pre-synaptic and post-synaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1 (presynaptic layer). In the case of a frame-based input (i.e., an input is in the form of a frame of a particular duration comprising spikes or pulses), the offset value μ can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant of a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and have stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics,

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a pre-synaptic neuron m to a post-synaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.,

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in biologically-consistent linear fashion. The time constant in the supra-threshold regime, positive by convention, reflects anti-leaky channel dynamics generally driving a cell to spike while incurring latency in spike-generation.

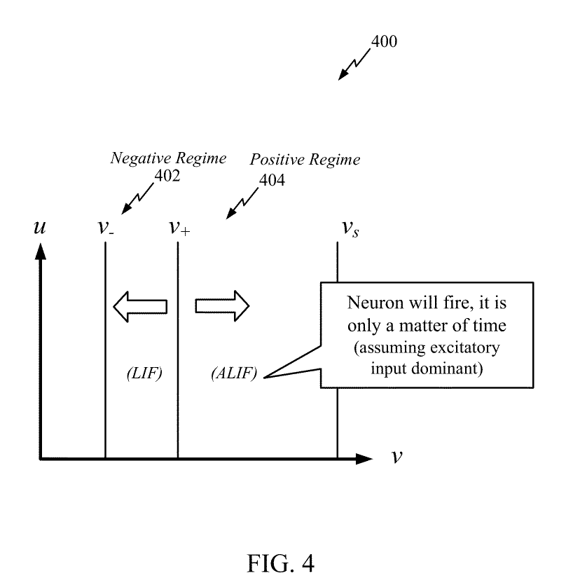

As illustrated in FIG. 4, the dynamics of the model may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as,

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ⁻ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are

q_{ρ}=−τ_{β}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter 8 is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model is defined to spike when the voltage v reaches a value vₛ. Subsequently, the state is typically reset at a reset event (which technically may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time involved to reach a particular state. The closed-form state solutions are

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{\frac{Δ t}{{τ}_{u}}} - r & ( 12 )\end{matrix}$$

Therefore, the model state may be updated only upon events such as upon an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches vₛ, then the closed-form solution for the amount of time, or relative delay, until a spike occurs as measured from the time that the voltage is at a given state v is

$$Δ {t}_{s} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily entail iterative methods or numerical methods. An event-based implementation is also possible at a limited time resolution in a step-based simulator by only updating the model if an event occurs at or between steps or by “step-event” update.

### Neural Coding

A useful neural network model, such as one comprised of the artificial neurons 102, 106 of FIG. 1, may encode information via any of various suitable neural coding schemes, such as coincidence coding, temporal coding or rate coding. In coincidence coding, information is encoded in the coincidence (or temporal proximity) of action potentials (spiking activity) of a neuron population. In temporal coding, a neuron encodes information through the precise timing of action potentials (i.e., spikes) whether in absolute time or relative time. Information may thus be encoded in the relative timing of spikes among a population of neurons. In contrast, rate coding involves coding the neural information in the firing rate or population firing rate.

If a neuron model can perform temporal coding, then it can also perform rate coding (since rate is just a function of timing or inter-spike intervals). To provide for temporal coding, a good neuron model should have two elements: (1) arrival time of inputs affects output time; and (2) coincidence detection can have a narrow time window. Connection delays provide one means to expand coincidence detection to temporal pattern decoding because by appropriately delaying elements of a temporal pattern, the elements may be brought into timing coincidence.

Arrival Time

In a good neuron model, the time of arrival of an input should have an effect on the time of output. A synaptic input—whether a Dirac delta function or a shaped post-synaptic potential (PSP), whether excitatory (EPSP) or inhibitory (IPSP)—has a time of arrival (e.g., the time of the delta function or the start or peak of a step or other input function), which may be referred to as the input time. A neuron output (i.e., a spike) has a time of occurrence (wherever it is measured, e.g., at the soma, at a point along the axon, or at an end of the axon), which may be referred to as the output time. That output time may be the time of the peak of the spike, the start of the spike, or any other time in relation to the output waveform. The overarching principle is that the output time depends on the input time.

One might at first glance think that all neuron models conform to this principle, but this is generally not true. For example, rate-based models do not have this feature. Many spiking models also do not generally conform. A leaky-integrate-and-fire (LIF) model does not fire any faster if there are extra inputs (beyond threshold). Moreover, models that might conform if modeled at very high timing resolution often will not conform when timing resolution is limited, such as to 1 ms steps.

Inputs

An input to a neuron model may include Dirac delta functions, such as inputs as currents, or conductance-based inputs. In the latter case, the contribution to a neuron state may be continuous or state-dependent.

### Example Method for Designing STDP Curves

Spike-timing dependent plasticity (STDP) is the basis of many biologically-inspired learning algorithms. In such systems, the connection between any pair of nodes (a synapse) is strengthened or weakened according to an STDP curve. The STDP curve describes how the synapse weight changes as a function of the time difference between the spikes of each node. A critical component of this approach is the exact form of the STDP curve. If the STDP curve is not exactly compatible with the spiking statistics of the two nodes, or many nodes in a large network, learning will take longer than expected and will most likely fail.

The typical approach to finding the STDP curve is to use parameter sweeps often together with loose heuristics. For example, a set of heuristics might consist of the following three statements: (1) positive time differences should increase the weight, (2) negative time differences should decrease the weight, and (3) the absolute weight change should decrease as the magnitude of the time difference increases. These heuristics would lead to a certain functional form of the curve (e.g., a double exponential), but would not specify the parameter values of the curve. At this point, the typical solution is to perform a parameter sweep to find a solution that allows learning. Parameter searches are often very costly in terms of time and computation, they may lead to “brittle” solutions (i.e., unstable solutions) where changing the input slightly breaks the system, and generally do not provide any insight into the system design.

Certain aspects of the present disclosure eliminate costly parameter searches and formalize the heuristics into a set of solvable equations that produce an exact solution for the STDP curve parameters. With such a set of equations, one can also analyze exactly how the curve will change if the firing statistics of the pre- and postsynaptic artificial neurons change. Furthermore, by integrating the synaptic plasticity design with neuron design, one can begin to answer functional questions regarding a network of spiking neurons. For example, one may ask, “What kind of spiking patterns can an artificial neuron with its plastic synapses decipher?” One can also introduce a measure of specificity or sensitivity of these spiking patterns based on the way the neuron is designed. More importantly, if these functional questions can be translated into parameter designs, one can start using spiking neurons in more abstract engineering problems. Certain aspects of the present disclosure provide a process for translating functional questions into network neuron parameters.

Certain aspects of the present disclosure provide a method of designing STDP curves for any arbitrary network of artificial neurons that uses STDP to learn relationships between input and output patterns. The method relies on knowing the statistics of the input to an artificial nervous system and the pre- and postsynaptic firing. The problem of setting the STDP curve may be reduced to a mathematical problem with six unknowns: two offsets, two amplitudes, and two rate parameters (e.g., time constants). The method generates six mathematical constraints by considering the asymptotic behavior, the limiting cases for depression and potentiation, and the typical case. By consulting the input statistics, one may determine the time period between the presentation of relevant features and, hence, how long a synapse should “remember” its learned weight. This period allows one to set the two asymptotic values. Similarly, but consulting the input statistics, one may determine the period during which the network will see a consecutive string of relevant features. Given this period and the expected number of synaptic updates, one may derive two more constraints assuming that the maximum potentiation/depression occurs for each feature. Finally, one may relax the assumption that maximum potentiation/depression occurs, look instead at the expected value of the potentiation/depression, and derive two more constraints. These six constraints take the form of a series of mathematical equations that can be solved exactly for the parameters of the STDP curves. Details of this method are provided below.

This method may also be used in conjunction with the neuron design to develop STDP curves. For example, assuming one can control the time to spike parameter (e.g., ALIF time constant in the Hunzinger Cold model), one may use this predicted time-to-spike to construct an STDP curve. The curve may be designed to be optimal in the following sense: given the desired rate of incoming spikes and the desired number of spikes to trigger the neuron, there is a known window of time within which the learning is optimal and potentiation may most likely occur. For example, if the desired pattern to fire the postsynaptic neuron is 10 presynaptic spikes arriving between 0.25 and 0.5 spikes/ms, then potentiation may most likely occur in a window from 20 to 40 ms. This window may then be shifted by adjusting the ALIF time constant. Once this potentiation window is determined, everything outside may be depressive, and the problem becomes one of finding a balanced depression region relative to the potentiation region. The solution to this problem is described in the previous paragraph and in greater detail below. The only differences may be that a different set of underlying equations would be used for the STDP curve (e.g., a Beta distribution with 2 shape parameters instead of a double exponential, as described below) and that the designer can control the position and scale of the STDP curve.

Certain aspects of the present disclosure have at least two main benefits. First, costly parameter searches need not be performed and are replaced with procedures (which may be performed by a simple script) that calculate the parameters exactly. This is significantly valuable in cases where the network is to be redesigned (e.g., to handle different inputs or more features). Second, techniques described herein allow mathematical analysis of how each STDP parameter affects learning, providing a determination of exactly how the learning will change as each parameter is adjusted. This can provide unparalleled insight into the learning rules, which may simplify other design constraints (e.g., training time or neuron design).

Certain aspects of the present disclosure are related to a general design methodology for constructing networks of Cold neurons and their corresponding spike-timing dependent plasticity (STDP) curves to learn any desired set of features. The method is generally applicable to any model containing Cold neurons (or any other neuron model having an adjustable time-to-spike variable) and STDP, including multi-layer networks. The method relies on a series of equations and, thus, may be automated, in full or in part.

The description below is divided into three sections. First, a high-level view of the design process is presented, and the trade-offs faced when using the method are discussed. Second, a derivation of the method is presented, relying on the visual Cold magno pathway as an example. This section provides the derivation and step-by-step instructions on how to use the method. Third, examples of applying the method in several different scenarios in the visual system are described.

Using this method, the performance of existing networks (e.g., artificial nervous systems) can be improved, and existing networks can be modified to accommodate different input.

### Overview of the Design Process

One main objective is to provide a quantitative design process that may be used to design any network of spiking neurons capable of learning with spike-timing dependent plasticity (STDP). In the past, the design process has consisted of a series of parameter sweeps often together with loose heuristics. The heuristics would lead to a certain functional form of the network, neurons and STDP curves, but would not specify the exact parameter values. At this point a parameter sweep (or a series of very educated guesses) would be performed to find a solution that allows learning. Parameter searches have three main drawbacks. First, they are often very costly in terms of time and computation. Second, they may lead to “brittle” (i.e., unstable) solutions where changing the input slightly breaks the system. Finally, parameter searches generally do not provide any insight into the system design.

With certain aspects of the present disclosure, costly parameter searches need not be performed, and the heuristics are formalized into a set of solvable equations that produce an exact solution for network parameters. Because one has a set of equations, one can also analyze exactly how the network behavior will change if the parameters or input(s) are changed.

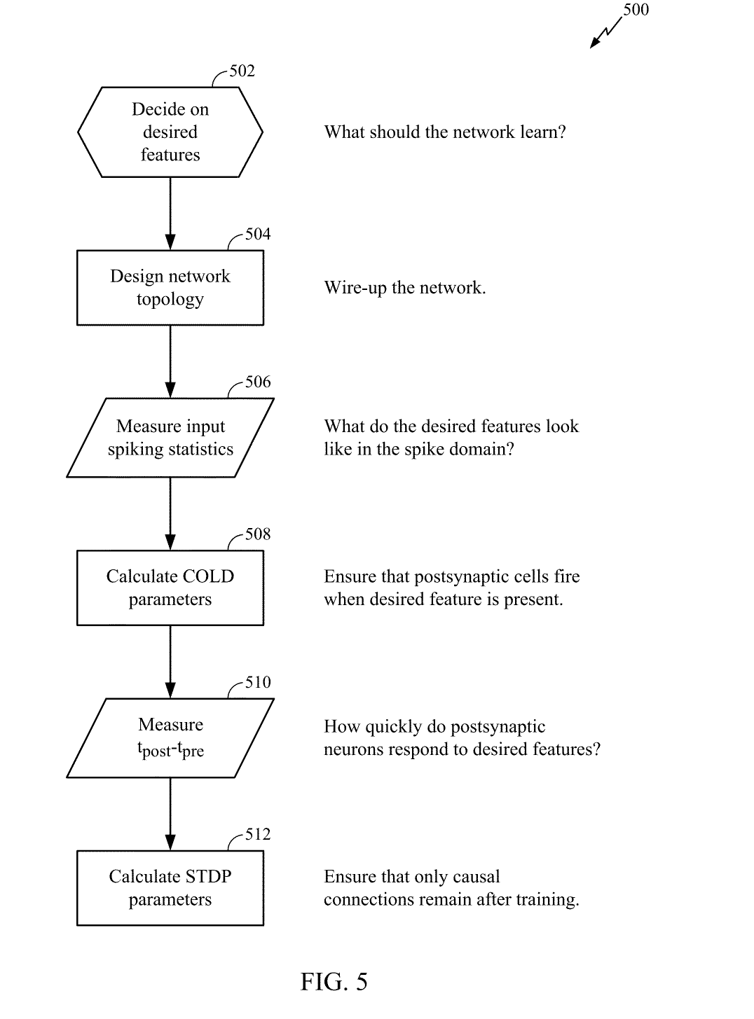

FIG. 5 shows the overall flow 500 of the design process. The design process begins, at 502, with a decision about what type of feature is to be learned. This could be a very abstract feature or a very simple feature, like a gabor-like filter with a specific spatial frequency.

The next step at 504 is to decide on a network topology, or what connects to what and with what fan-in or fan-out ratios. This topology is mostly constrained by structure of the incoming feature. In vision, for example, one expects the feature to come from a two-dimensional image and span a certain spatial extent (possibly related to a spatial frequency). The fan-in or fan-out ratios provide constraints on the synapse weights.

After the network has been wired up according to the chosen topology, one may determine what the features look like in the spike domain at 506. The spike domain corresponds to the firing statistics of the neurons that are presynaptic to the neurons that will learn the feature. These spiking statistics may be derived from a known model of how the feature maps to the spike domain, or by simply running the model and measuring what presynaptic spike patterns correspond to the desired feature.

The presynaptic firing statistics may form the basis for designing the postsynaptic Cold neuron parameters at 508. The neuron parameters may be designed such that there is a high probability of the postsynaptic cell firing if the desired feature is present. In essence, the LIF region is used to detect the relevant feature, and the ALIF region is used to diversify the selectivity within the feature type. For example, in the vision model, the LIF region may be used to detect an edge feature, and the ALIF region may be used to diversify among the edge orientations so that neighboring postsynaptic cells are selective for different orientations.

After the postsynaptic cells have been designed, one may determine how quickly the postsynaptic neurons respond to the desired features at 510. This may be accomplished by measuring the difference in the postsynaptic and presynaptic spike times. These times are then used to determine the expected number of long-term potentiation (LTP) and long-term depression (LTD) events to constrain the STDP curve. This is accomplished by only considering those timing differences that would be considered by the STDP rules. For example, in a triplet STDP rule, only the nearest post-pre timing differences are considered during an LTP update.

Finally, using the expected LTP and LTD event distributions and some knowledge of how often the network will see a relevant feature, one can calculate the parameters of the STDP curve at 512. The exact parameters of the STDP curve are critical for learning and will affect the amount of time to train the network.

For a simple network with only one input and one output layer, the design process in FIG. 5 may be completed only once. As more layers are added together, however, the process proceeds through iteration of all connected pairs of layers. In principle the design process could tackle the three main components (topology, neuron parameters, and STDP) in any order. The order presented herein has been chosen because it follows a natural progression and produces the straightforward series of equations described in the next section.

As with any design methodology, there are certain trade-offs faced during the design method presented herein. These range from simple cases of deciding how many samples are implicated to estimate a parameter up to methodological considerations like whether to achieve feature selectivity through the Cold neuron parameters, through the STDP curve, or both.

Many small trade-offs between number of samples and accuracy were made throughout the derivation and may be modified for different models. Most importantly, however, feature selectivity is achieved through the LIF region of the Cold neuron. This selectivity is not perfect. It allows one to select features that have at least x presynaptic spikes arriving no slower than a given rate. Features associated with more than x presynaptic spikes or less than x presynaptic spikes arriving faster than the given rate will also be learned. Greater control of feature selectivity could be achieved by using a two-dimensional Cold neuron instead of the one-dimensional Cold neurons employed here, but it was decided to keep the neuron model as simple as possible. Similarly, feature selectivity may also be enforced by more exotic STDP curves (e.g., a Beta distribution with 2 shape parameters, as described below), but the simple double exponential was kept for the derivation below. In other words, feature selectivity was traded for model simplicity. While this trade-off works well for the vision models considered here, other models may indicate a different trade-off.

### Designing Parameters for Networks of Cold Neurons Given Presynaptic and Stimulus Statistics

The design is broken into four basic stages: topology design, excitatory design, inhibitory design, and plasticity design. While these are all codependent, the method below provides a straightforward process for calculating each parameter from the input statistics and the desired behavior. The vision model is used as an example to illustrate the process, but this method may apply to any artificial nervous system.

### Topology Design

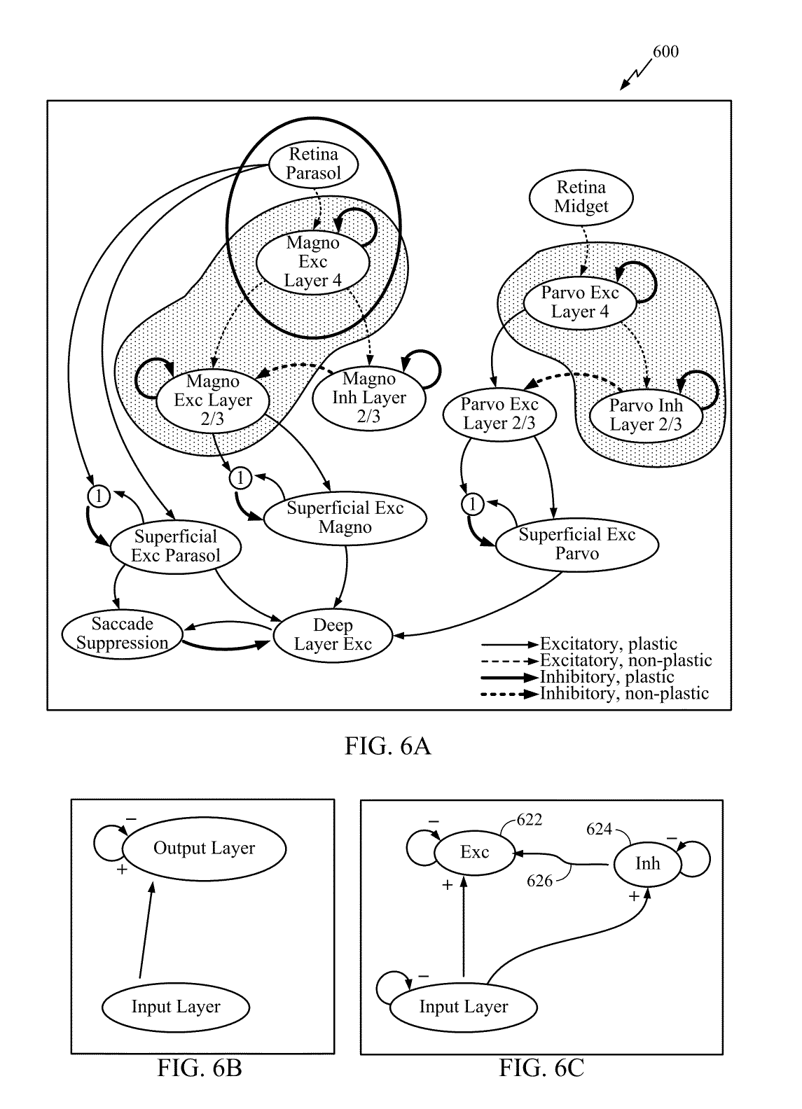

The very first thing one may most likely determine is what the basic structure of the network will look like. This basic structure may be very different depending on the model. However, despite the number of neurons or connections, many models may be broken down into a series of neuron groups that are directionally connected, such as the vision model 600 shown in FIG. 6A.

Furthermore, these networks can usually be decomposed into pairs of neuron groups that are connected by a small number of connection types, such as the one circled in FIG. 6A. In these connected pairs, one group of neurons can typically be called the “input group” or “input layer,” which is presynaptic to the second “output group” or “output layer.” In FIG. 6A, the retina midget cells are the input layer, and the parvo exc layer 4 cells are the output layer. The following design methodology assumes that one is working with connected pairs of neuron groups.

After the two groups of neurons have been identified, the number (n_{fanin}) of presynaptic neurons that will project onto a single postsynaptic neuron may be determined. This number constrains the starting weight and bounding weights, which in turn constrain the rest of the parameters. n_{fanin} is entirely dependent on the features one wishes to extract from the stimulus or preceding neural layer. These features are extremely model dependent, and so, examples are provided in the next section below, with one simple example provided here that will be used for the following discussion. The example used is the design of the layer 4 magno cells in the Cold model when trained on an image (e.g., the image of Building N on the Qualcomm, Inc. campus in San Diego, Calif.).

When designing the magno layer 4 cells, a design decision was made to extract gabor-like features with a spatial frequency of 48 pixels/cycle. To capture this frequency, the magno layer 4 cells have circular receptive fields with a diameter equal to or greater than 48 pixels. From the topology of the retina, one can calculate that approximately 10 retinal parasol cells may project to each magno layer 4 cell to achieve a receptive field diameter greater than 48 pixels. Since there are two classes of parasol cells (on-cells and off-cells), which are roughly co-located, one can define n_{fanin} to equal 19 (it is not twenty since the cells are not exactly collocated).

Once n_{fanin} is known, the design of the Cold neuron parameters may begin.

### Excitatory Neural Design

The basic idea behind the excitatory design is to determine the weights of presynaptic excitatory connections (wᵢₙᵢₜ and wₘₐₓ) and the leak parameter (τ₋) that will cause a postsynaptic neuron to spike in the presence of a desired pattern. This can be seen as a detection problem, and to simplify the design, one can consider this as a problem of how to get the neuron to the ALIF region during relevant patterns. Since the LIF and ALIF region of the Cold neuron are independent, one can use the LIF region to design the excitatory behavior and the ALIF region to design the inhibitory behavior.

For certain aspects, the synaptic weights may be set, and then the leak parameter may be adjusted based on these weights. Since these weights are plastic, their initial value (wᵢₙᵢₜ) and their final values (wₘᵢₙ and wₘₐₓ) may be considered. One may set wₘᵢₙ to zero because there are likely some connections that are not desired to contribute to the final receptive field at all. This leaves only the initial and maximum weights to consider.

To set the initial weight, the case without leak is considered. In this case, the weight of each synapse may be the voltage difference between v₋ and v₊ divided by the average number of spikes (sₚᵣₑ) one expects to see in a single neuron's receptive field during a given time window (T). The voltage difference is specified by the voltage thresholds. The number of spikes one expects to see may be measured from the statistics of the presynaptic spiking layer. To measure this expectation, one may determine the average number of spikes from all neurons in the presynaptic layer during time window T, referred to as E[sₚᵣₑ|T]. Dividing by the total number of neurons in the layer, Nₚᵣₑ, gives the percentage of cells firing in the presynaptic layer during time window T. Multiplying this by the number of cells in a presynaptic receptive field yields sₚᵣₑ, as shown in Eq. 15.

$${w}_{init} = \frac{( {v}_{+} - {v}_{-} )}{\frac{E [ {s}_{pre} \vert T ]}{{N}_{pre}} {n}_{fanin}} \qquad ( 15 )$$

Importantly, however, the equation above does not consider the variance in the number of spikes one expects to observe in a given time window. If the variance is zero, then when the leak is added in, the postsynaptic neuron would never spike unless all spikes were simultaneous. To account for the variance, one may subtract twice the standard deviation (SD) of the spike times to account for ˜98% of the variance.

$${w}_{init} = \frac{( {v}_{+} - {v}_{-} )}{\frac{E [ {s}_{pre} \vert T ] - 2 SD [ {s}_{pre} \vert T ]}{{N}_{pre}} {n}_{fanin}} \qquad ( 16 )$$

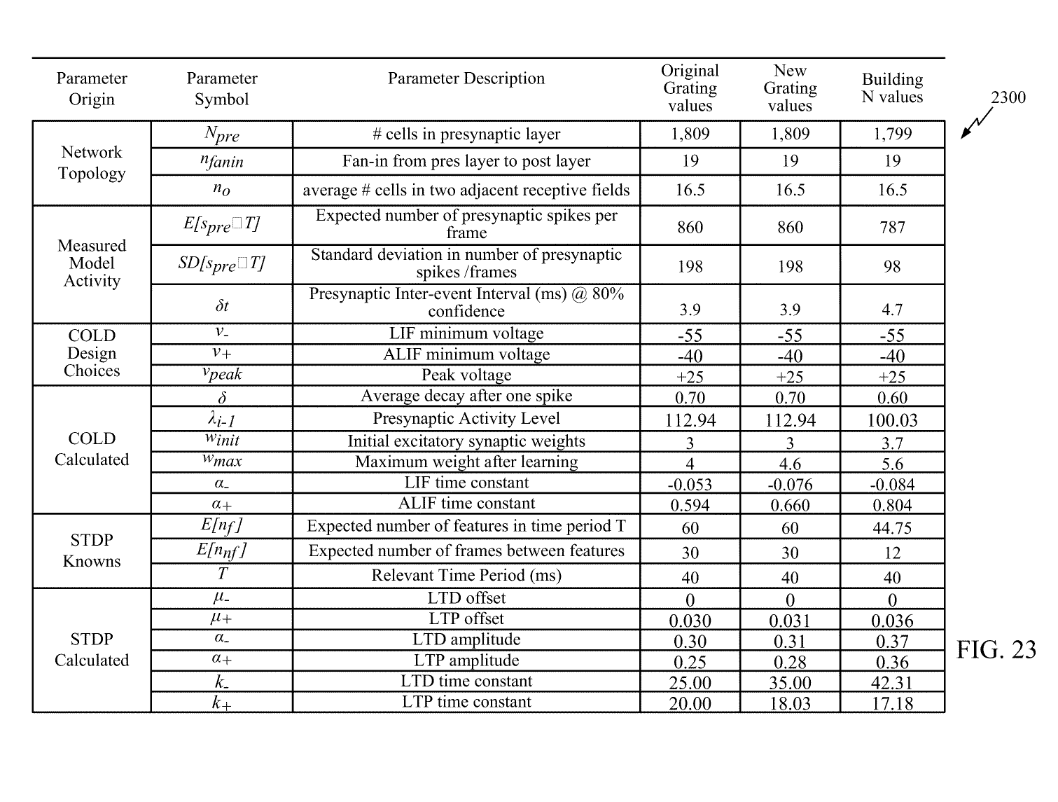

For the case of the magno layer 4 V1 model here using the values in table 2300 of FIG. 23, one can see that the initial weight for the Building N training retinal statistics should be 3.7.

Now that the initial weight is set, one may determine the maximum weight to which one can potentiate. This weight will be higher than wᵢₙᵢₜ by a factor related to the fraction of fan-in inputs contributing to firing the postsynaptic neuron. This involves considering how many spikes one expects to see for the pattern (p) one wants to learn, E[sₚᵣₑ|T, p]. In the case of layer 4 of the magno pathway, for example, it is desired to learn edge-like patterns, which typically have as many white areas as black areas. Given that our retina field (RF) is made up of 50% on cells and 50% off cells, one can expect that when a gabor-like pattern of relevant size is presented in the RF of a layer 4 neuron, half of the presynaptic cells will spike on average. According to Eq. 17, this would lead to a maximum weight of 5.6.

$${w}_{max} = ( 1 + \frac{E [ {s}_{pre} \vert T , p ]}{{n}_{fanin}} ) {w}_{init} \qquad ( 17 )$$

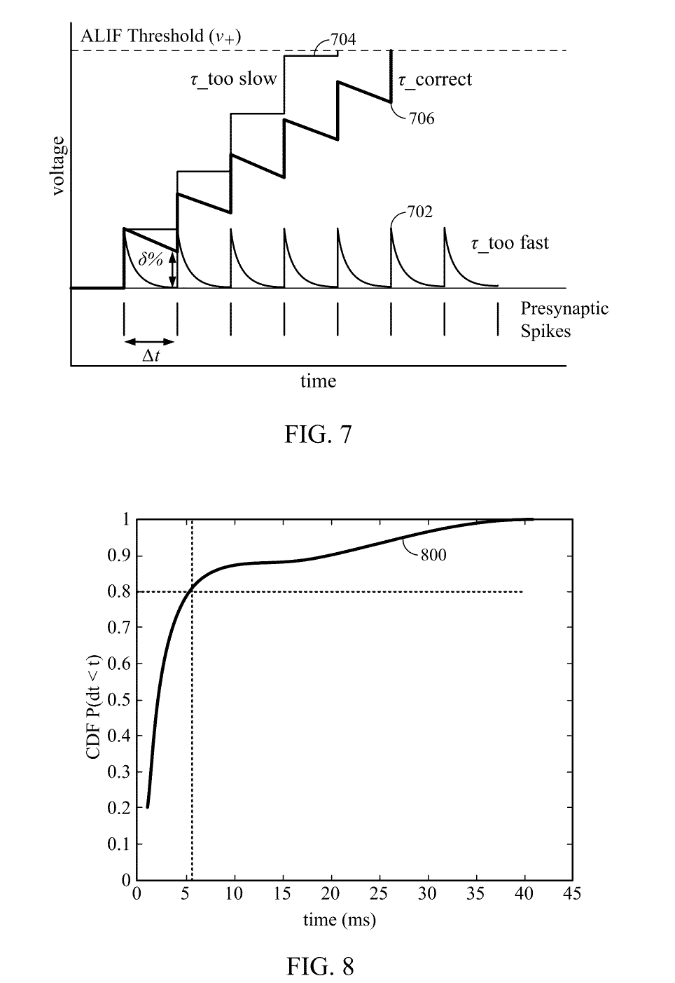

Now that the weights are set, the leak in the LIF region may be considered. The τ₋ may be adjusted such that the voltage decay between spikes still allows for integrating sₚᵣₑ presynaptic inputs that arrive with a given distribution of inter-spike intervals. As illustrated in FIG. 7, if the decay is too fast (as in plot 702), one could potentially not integrate any spikes, and if it is too slow (as in plot 704), one could end up integrating over spikes that are not causally related. The desirable decay lies somewhere between these two extremes (as in plot 706). The voltage decay in the LIF region is simply an exponential decay, so the time constant may be expressed as

$${τ}_{-} = \frac{- Δ t}{ln ( δ )} \qquad ( 18 )$$

where Δt is a random variable describing the inter-spike intervals and δ is the fractional amount of voltage left when the next spike arrives (see FIG. 7). Thus, to calculate τ₋, values for Δt and δ may be determined.

The amount of decay, δ, is easily derived by considering a process that has a constant Δt. As shown in FIG. 7, the voltage at the time of the sₚᵣₑ^{th} spike arrival may be expressed according to Eq. 19. Although there is no closed-form solution for δ from this equation, both Matlab and Mathematica can easily solve for δ given sₚᵣₑ, wₘₐₓ, v+ and v₋. In the case of the layer 4 design, δ=0.60.

$$( {v}_{+} - {v}_{-} ) = {w}_{max} {\sum }_{i = 0}^{{s}_{pre}} {δ}^{i} \qquad ( 19 )$$

To find Δt, it may be desired to convert it from a random variable to a single value so that a single value can be generated for τ₋. One way to do this would be to use the mean; however, there are two reasons this is not a good solution. First, the distribution of Δt is typically highly skewed to the right, making the mean a poor measure of a typical inter-spike interval. Second, even if the Δt distribution was normal, choosing the mean as Δt would ensure that half of the time, spikes would arrive when the voltage had decayed below δ%, and this would preferentially weight earlier spikes as compared to later spikes. Instead, a better way to choose Δt is to find the 80^{th} percentile of the distribution, or the time at which one is 80% likely to have observed the next spike. The 80^{th} percentile is convenient for the V1 layer 4 model, but any reasonable percentile may be chosen.

The most general way to calculate the 80^{th} percentile of the Δt distribution is to empirically measure the inter-spike intervals within each neurons receptive field, calculate the cumulative probability distribution, and find the time when it equals 0.8. Of course if there is a parametric distribution that describes the inter-spike intervals, the 80^{th} percentile can be explicitly calculated. In the case of the Building N image, the parasol cells reach an 80% probability of having spikes at Δt=4.7 ms, as shown in the cumulative distribution function (CDF) 800 of FIG. 8. Plugging Δt and τ into Eq. 19 yields a τ₋ of −11.9.

### Inhibitory Neural Design

Setting the inhibitory parameters involves considering primarily the ALIF region of the Cold neuron. From the LIF region's point of view, there are two reasons an artificial neuron would not spike: (1) not enough excitatory inputs or (2) too many inhibitory inputs. In the ALIF region, however, inhibition is the only way to prevent a neuron from spiking. With this in mind, the inhibitory parameter design in the ALIF region is considered below.

In the case of recurrent inhibition where Dale's law is violated, an excitatory neuron inhibits its neighbors (see FIG. 6B). In this case it is not possible to consider the firing statistics of excitatory and inhibitory neurons separately, since they are one and the same and to calculate either, a τ₊ may most likely have already been assumed. As in the excitatory case, the weight will be set first, followed by the time constant.

To set the weight, it is decided how many spikes (sᵢₙₕ) to allow before the inhibited neuron is pushed below v₋ back into the LIF regime. The ALIF voltage range is divided by that number of spikes to get the inhibitory weight. The sᵢₙₕ is model dependent. In the layer 4 vision model, a winner-take-all operation among each group of nine neurons is desired, so only one neuron spiking may most likely quell the rest, yielding a wᵢₙₕ of 65 (see table 2300 in FIG. 23).

$${w}_{inh} = \frac{{v}_{peak} - {v}_{+}}{{s}_{inh}} \qquad ( 20 )$$

To design the inhibition time constant in the recurrent case, one may determine the worst case scenario for when two artificial neurons are both in the ALIF region and only one artificial neuron should spike. The worst case scenario happens when both neurons cross the v₊ boundary at the same time with the same amplitude. If this happens, there is no way to distinguish which neuron should fire and possibly potentiate. However, a scenario that could provide a distinction occurs when two neurons cross the boundary at the same time, but one has a higher voltage than the other. In this case, one may want the neuron with the higher amplitude to spike and inhibit the other.

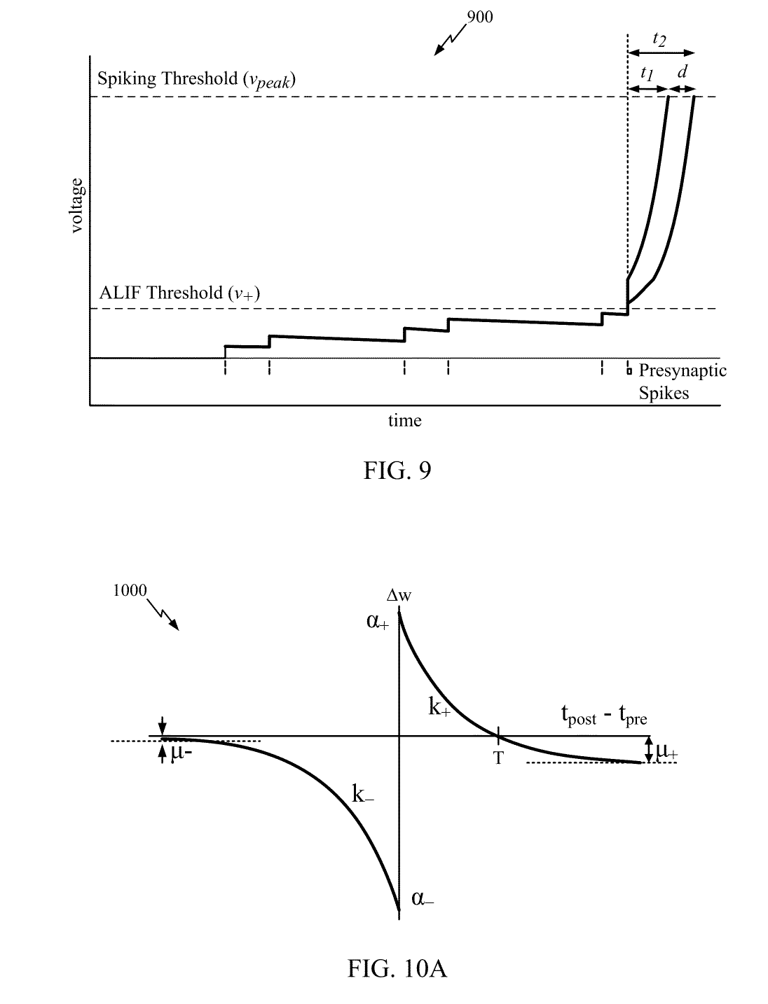

The graph 900 of FIG. 9 shows such a scenario. In this limiting case, one may want to ensure that the time for neuron B to reach the vₚₑₐₖ threshold (t₂) is greater than the time for neuron A to reach the threshold (t₁), plus the time it takes for inhibition to arrive at neuron B (d):

t₂>t₁+d (21)

Assuming a simple exponential rise with time constant τ₊, one can derive the following relationship for τ₊:

$${τ}_{+} < \frac{d}{ln ( \frac{( {v}_{peak} - {v}_{-} ) - {v}_{2}}{( {v}_{peak} - {v}_{-} ) - {v}_{1}} )} \qquad ( 22 )$$

The question then becomes, how much of a difference between v₁ and v₂ matters? This minimum difference may depend on the model being used. For example, in the layer 4 vision model, there is a large overlap in receptive fields between neighboring neurons. Two neighboring cells will share 16.5 of their inputs, and 2.5 of them will be different. If one assumes that the common inputs for both neurons will get them into the ALIF region, then the difference is of concern if neuron B has only the common inputs and neuron A has the common inputs in addition to the 2.5 extra inputs. In this case, one may want only neuron A to fire and neuron B to be inhibited by it. One may calculate the v₊ that will ensure that neuron B is inhibited using Eq. 23 below, assuming the synaptic delay is 1 ms. For this case, a maximum τ₊ of 1.24 will ensure that if two neurons cross the threshold at the same time with a voltage difference of 2.5*wᵢₙᵢₜ, only the neuron with the higher voltage will spike.

$${τ}_{+} < \frac{1}{ln ( \frac{( {v}_{peak} - {v}_{-} ) - {n}_{0} ( \frac{E [ {s}_{pre} \vert T ]}{{N}_{pre}} ) {w}_{init}}{( {v}_{peak} - {v}_{-} ) - {n}_{fanin} ( \frac{E [ {s}_{pre} \vert T ]}{{N}_{pre}} ) {w}_{init}} )} \qquad ( 23 )$$

Next, the case is considered where there are two separate populations of artificial neurons, one excitatory 622 and one inhibitory 624, and one connection 626 from the inhibitory population that inhibits the excitatory population (see FIG. 6C). The design of the inhibitory neurons will follow the same procedure described above for the LIF region and the ALIF region with recurrent inhibition. The excitatory population, however, may have to consider non-recurrent inhibition.

As for recurrent inhibition, the weight of the inhibitory synapse may be set equal to the voltage difference between Vₚₑₐₖ and v₊ divided by the number of inhibitory spikes to fully inhibit a given artificial neuron (see Eq. 20).

To set the time constant of the ALIF region, the spiking statistics of the separate inhibitory population may now be considered. t₊ may be set such that the rise to the spiking threshold is as fast as possible while still allowing time for at least sᵢₙₕ spikes to potentially inhibit the spiking. Thus, one may determine the amount of time involved to observe sᵢₙₕ spikes with some probability, γ.

This time may be determined by either measuring it explicitly from recorded inhibitory spikes or by assuming a spike generation model (e.g., a Poisson process) and solving for the time. In both cases, the complementary cumulative distribution function (CCDF)—or the probability of observing at least sᵢₙₕ spikes as a function of time—may be computed. With the CCDF, one can calculate the time at which the CCDF is equal to the chosen γ. This time, tᵢₙₕ, is the time involved to observe at least sᵢₙₕ spikes with a probability of γ. For example, in layers ⅔ of the magno pathway, the time involved to observe one spike is 55 ms for an assumed probability of 0.9.

With this time, τ₊ may be derived according to the following equation arising directly from the Cold model, which involves a simple exponential rise from v₊ to vₚₑₐₖ.

$${τ}_{+} = \frac{{t}_{inh}}{ln ( {v}_{peak} - {v}_{+} )} \qquad ( 24 )$$

### Plasticity Design

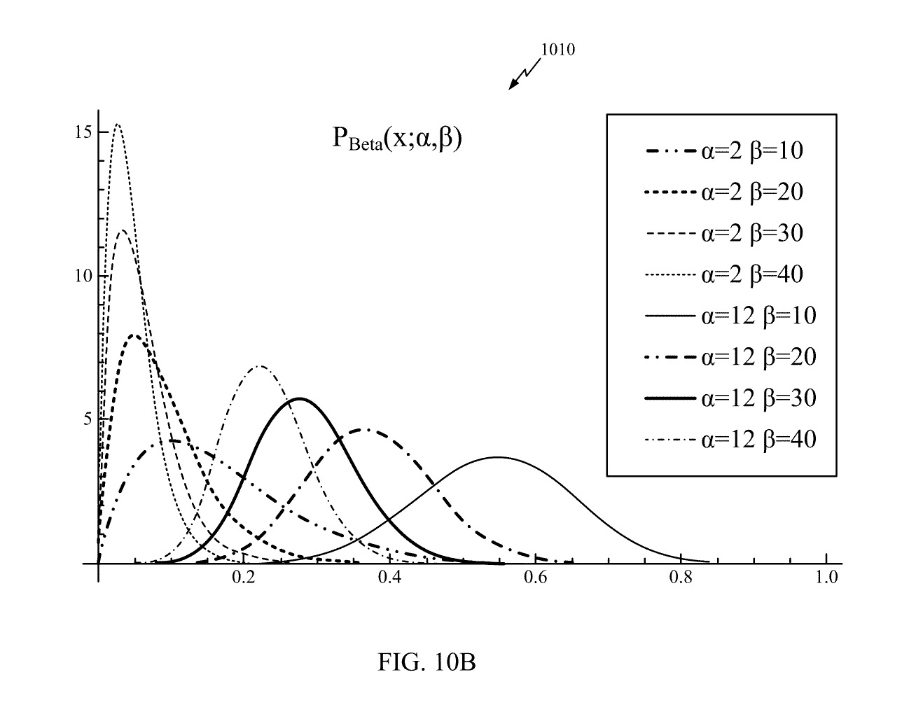

The last set of parameters to design the system is the parameters for the spike-timing dependent plasticity (STDP) curve. Although other functional forms of the STDP curve may be used (e.g., a double linear, a double logarithm, a polynomial function based on the Beta distribution, or combinations of functions, such as an exponential LTP combined with a linear LTD), the typical plasticity curve may be described by the following double exponential equation, which is plotted in the graph 1000 of FIG. 10A:

$$Δ w ( δ t ) = \{ \begin{matrix}{α}_{+} {e}^{- δ t / {k}_{+}} - {μ}_{+} , & δ t > 0 \\ - ( {α}_{-} {e}^{- δ t / {k}_{-}} + {μ}_{-} ) , & δ t < 0\end{matrix} \\ where δ t = {t}_{post} - {t}_{pre} . \qquad ( 25 )$$

The basic intuitions for setting the STDP parameters come from the desire to only potentiate synapses that are causal of the postsynaptic spikes and to potentiate at a “suitable” rate. The expected amounts of LTP and LTD will depend not only on the incoming spike relationships, but also on the frequency of the desired feature in the stimulus and the specific STDP rules (e.g. triplet, resources-based, etc.). The problem of setting the STDP curve is essentially a problem of six unknowns. The general approach involves finding constraints by considering the asymptotic behavior, the limiting case for potentiation, the limiting case for depression, and the typical case. Importantly, the method below should be applicable to many functional forms of the STDP curve, although the equations are derived for the double exponential function below.

Asymptotic Behavior

Potentiation may be considered first. In the case of the vision model, there is a clear period after which a presynaptic and postsynaptic spike should not be related to each other. Namely, if a pre- and postsynaptic spike are more than the period of one frame apart, then the presynaptic spike may most likely not be associated with the postsynaptic spike. This means that for δts greater than this relevant period, T, depression of the synaptic weights is desired. The consequence of this is that the LTP curve may most likely dip below the δt-axis at time T. This can be expressed as

Δw(δt)=α₊e^{-T/k}^{₊}+μ₊=0 (26)

and constitutes the first constraint. While the period is set here by the frame rate assuming a stroboscopic visual system, there is likely also a relevant period in a continuous visual system. In that case, the relevant period may be set by the expected rate of change of the environment, or, in an active, continuous visual system, by the statistics of the sensor's movement (e.g., saccade frequency). Similarly, there is likely to be a relevant period in other models, as well.

Next, one may consider how much depression is warranted for large, positive δts, which will allow μ₊ to be set. Since μ₊ serves to depress a synaptic weight between two postsynaptic spikes, μ₊ may be considered as the rate of depression in the gaps between relevant features. That is, if a synapse has fully potentiated (i.e., learned a feature), μ₊ is the rate at which the weight will return to the initial value, wᵢₙᵢₜ, if the learned feature is absent. Colloquially, this is the time allowed for the synapse to “forget” its learned weight.

If the desired features appear infrequently in the training stimulus, this rate may be slow (a low μ₊), but if the desired features appear very frequently, this rate may be faster (a high μ₊). By considering the statistics of the training stimulus, it is possible to obtain an estimate of the expected length of a gap between two relevant features, E[nnf]. For the visual case, this means calculating how often a horizontal or vertical edge is not present in a layer 4 receptive field. The section below describes how this calculation was made for the Building N image. Once the expected value of the gap length is known, the difference between the initial and maximum weights may be divided by this gap length to arrive at the decay rate, μ₊.

$${μ}_{+} = \frac{( {w}_{max} - {w}_{init} )}{E [ {n}_{nf} ]} \qquad ( 27 )$$

Depression may be considered next. There is likely not a zero-crossing for depression, since that would imply that a weight should increase if the presynaptic spike happened a certain delay after the postsynaptic spike. While this might be useful in the case of an oscillating input, it is most likely not relevant because in such a case, the weight would have already been potentiated by the LTP curve. The magnitude of the depression curve may be used to enforce depression for cases where the presynaptic spikes happen long after the postsynaptic spikes. However, since this case is accounted for by the negative portion of the potentiation curve, one need not account for it here. Thus, the depression offset may be set to zero, providing a third constraint.

μ₋=0 (28)

The Limiting Case for Potentiation

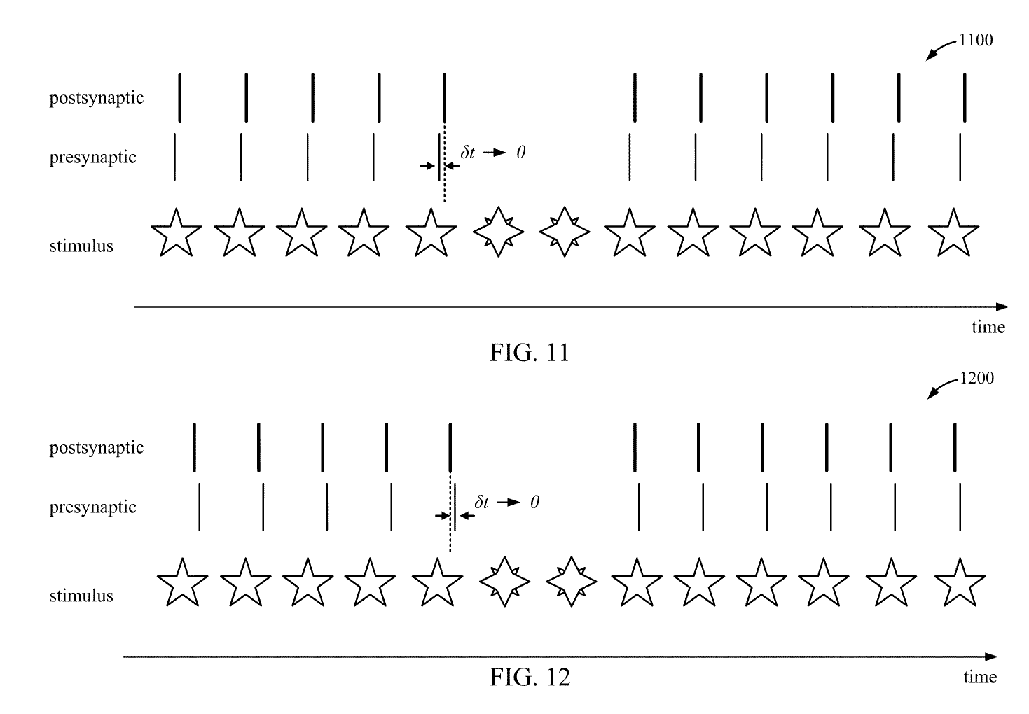

In the limiting case for potentiation, a presynaptic neuron would fire once just before the postsynaptic neuron, and the feature to be learned would be present every time the postsynaptic neuron fired. In the case of the vision model, this translates to a scenario where the presynaptic neuron fires once per frame just before the postsynaptic neuron, the postsynaptic neuron fires only once per frame, and the frames always contain a relevant feature. This scenario is illustrated in the spike timing diagram 1100 of FIG. 11.

For this case, one may want to fully potentiate this synapse (that is, take its weight from wᵢₙᵢₜ to wₘₐₓ) over the course of time this behavior is expected to keep occurring. Formally, the expected total change in the weight, E[ΔW], may most likely be equal to the potentiation range:

E[ΔW]=(wₘₐₓ−wᵢₙᵢₜ) (29)

If the expected number of times this synapse will be active, E[nf], is known, the equation can be rewritten in terms of the expected value of the LTP and LTD weight updates, Δw_{LTP} and Δw_{LTD} as follows:

E[ΔW]=(wₘₐₓ−wᵢₙᵢₜ)=E└n_{f}┘(E[Δw_{LTP}]−E[Δw_{LTD}]) (30)

Importantly, if the Cold design is completed correctly, then one may expect that, on average, the synapse will be active each time the desired feature is present in the input. Thus, E[nf] may be calculated a priori by determining how often the desired feature is present in a postsynaptic neuron's receptive field during the training stimuli. For the visual case, this means calculating how often a horizontal or vertical edge is present in a layer 4 receptive field. The section below describes how this calculation was made for the Building N image.

Because the limiting case scenario is being considered, one may assume that the delay between the presynaptic and postsynaptic spikes are exactly the same each time and that there is a constant period, T, between each presynaptic spike. If one makes these assumptions and rearranges, the equation becomes:

$$\frac{( {w}_{max} - {w}_{init} )}{E [ {n}_{nf} ]} = Δ w ( 0 ) - Δ w ( T ) \qquad ( 27 )$$

Plugging in from Eq. 24, one obtains:

$$\frac{( {w}_{max} - {w}_{init} )}{E [ {n}_{nf} ]} = {α}_{+} - {μ}_{+} - ( {α}_{-} {e}^{- T / {k}_{-}} + {μ}_{-} ) \qquad ( 32 )$$

This is the fourth constraint.

The Limiting Case for Depression

The limiting case for depression is essentially the same as for potentiation, except that the presynaptic neuron fires immediately after every postsynaptic spike. This scenario is illustrated in the spike timing diagram 1200 of FIG. 12.

In this case, the weight of this synapse may be driven to zero over the course of time this behavior is expected to keep occurring. Similar to the case for potentiation, one can write

E[ΔW]=(wᵢₙᵢₜ−0)=E└n_{f}┘(E[Δw_{LTP}]−E[Δw_{LTD}]) (33)

Assuming, as above, that there is a constant period between the presynaptic spikes, the equation becomes:

$$\begin{matrix}\frac{( {w}_{init} - 0 )}{E [ {n}_{f} ]} = Δ w ( T ) - Δ w ( 0 ) & ( 34 ) \\ \frac{{w}_{init}}{E [ {n}_{f} ]} = ( {α}_{+} {e}^{- T / {k}_{+}} + {μ}_{+} ) - {α}_{-} - {μ}_{-} & ( 35 )\end{matrix}$$

Conveniently, the crossover point was chosen to occur at the end of the relevant period, T, making the first term in the equation equal to zero (see Eq. 26) and simplifying to:

$$\frac{{w}_{init}}{E [ {n}_{f} ]} = - {α}_{-} - {μ}_{-} \qquad ( 36 )$$

This is the fifth constraint.

The Typical Case

While the limiting cases for potentiation and depression are useful sources of constraints, the model will operate more often somewhere between these two extremes. More typically, one will want to potentiate a synapse over the course of many periods where the LTP and LTD updates are stochastic. Thus, the expected values of the updates may most likely be considered, not just their extrema.

$$\frac{( {w}_{max} - {w}_{init} )}{E [ {n}_{f} ]} = E [ Δ {w}_{LTP} ] - E [ Δ {w}_{LTD} ] \qquad ( 37 )$$

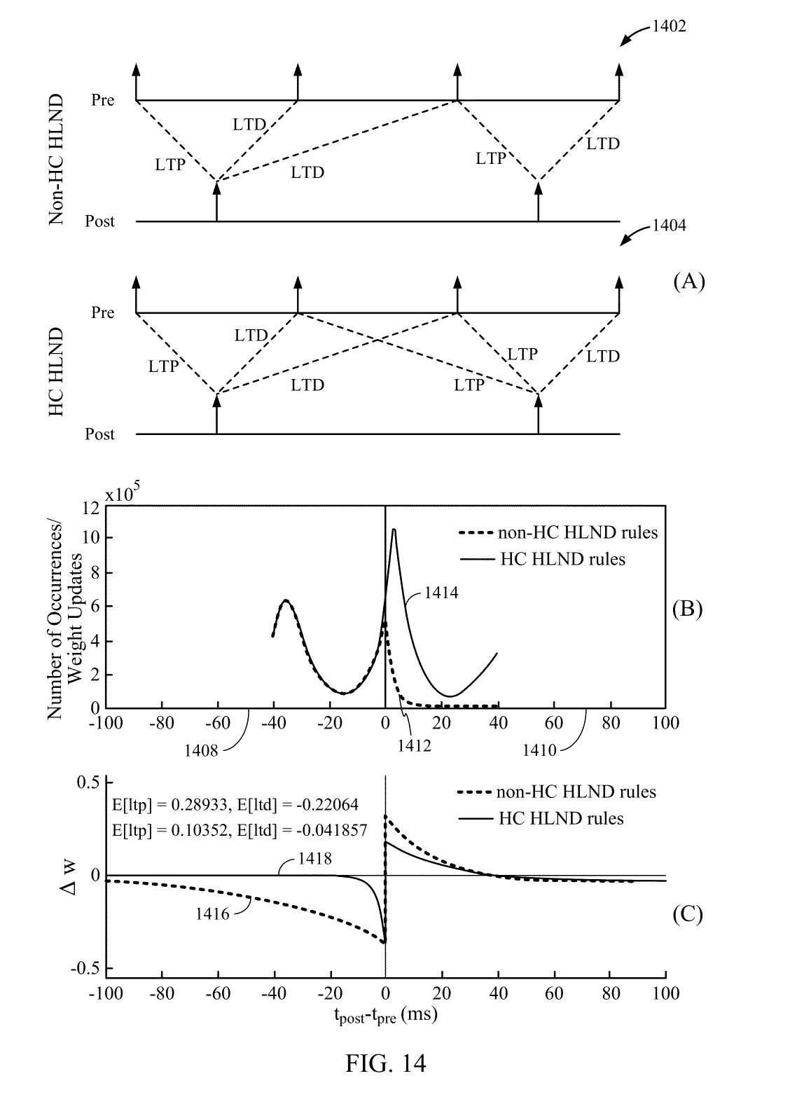

The expected value of the LTP and LTD updates are derived by considering the value of all updates over a given period. In the vision model, for instance, a relevant period is 40 ms, or one frame.

$$\begin{matrix}E [ Δ {w}_{LTP} ] = {\int }_{0}^{T} {p}_{LTP} ( δ t ) ( {α}_{+} {e}^{- δ t / {k}_{+}} - {μ}_{+} ) d δ t & ( 38 ) \\ E [ Δ {w}_{LTD} ] = {\int }_{0}^{T} {p}_{LTD} ( δ t ) ( {α}_{-} {e}^{- δ t / {k}_{-}} + {μ}_{-} ) d δ t & ( 39 )\end{matrix}$$

where pLTP(δt) and pLTD(δt) are the probability of observing a particular pre-post 6t in the LTP and LTD regions, respectively. These distributions may be measured directly from the model or may be theoretical. Importantly, however, the distributions will depend critically on the STDP rules one plans to use (see non-HC HLND lines in FIGS. 14B and 14C). This is the sixth constraint.

Using some algebra and converting the integrals to discrete sums, one can combine all of the constraints and write an equation with only one unknown, k+:

$$\begin{matrix}\frac{( {w}_{max} - {w}_{init} )}{E [ {n}_{f} ]} = \{ {\sum }_{i = 0}^{T} {\vec{p}}_{LTP} [ δ {t}_{i} ] ( {α}_{+} {e}^{- δ {t}_{i} / {k}_{+}} - {μ}_{+} ) - {\sum }_{i = 0}^{T} {\vec{p}}_{LTD} [ δ {t}_{i} ] ( {α}_{-} {e}^{- δ {t}_{i} / {k}_{-}} + {μ}_{-} ) \} \\ where {α}_{+} = {μ}_{+} / {e}^{- T / {k}_{+}} and & ( 40 ) \\ {k}_{-} = \frac{- T}{ln ( \frac{\frac{( {w}_{max} - {w}_{init} )}{E [ {n}_{f} ]} - ( \frac{{μ}_{+}}{{e}^{- T / {k}_{+}}} ) + {μ}_{+} + {μ}_{-}}{- {α}_{-}} )} & ( 41 )\end{matrix}$$

To ensure that the value of k− is positive, there are upper and lower bounds on the value of k+ (Eq. 42). The lower bound on k+ ensures that the quantity inside the natural logarithm of the k− denominator is less than 1, and the upper bound on k+ ensures that the quantity inside the natural logarithm of the k− is positive.

$$\frac{- T}{ln ( {μ}_{+} / \frac{( {w}_{max} - {w}_{init} )}{E [ {n}_{f} ]} + {μ}_{+} + {μ}_{-} + {α}_{-} )} < {k}_{+} < \frac{- T}{ln ( {μ}_{+} / \frac{( {w}_{max} - {w}_{init} )}{E [ {n}_{f} ]} + {μ}_{+} + {μ}_{-} )} \qquad ( 42 )$$

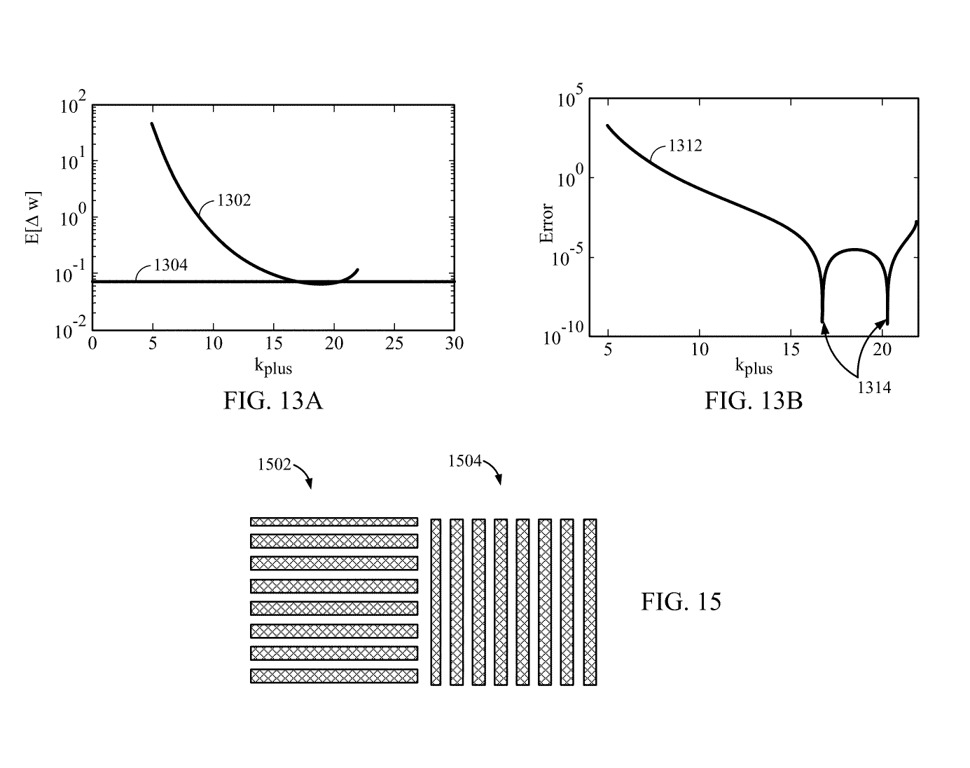

Although there is no convenient closed-form solution to this equation, k+ may be found by numerical means, which may be accomplished using any of various suitable numerical mathematics software packages, such as Matlab or Mathematica. FIG. 13A shows an example of this curve 1302 for the layer 4 magno vision model, demonstrating that this is a smooth curve with at most two solutions for k₊. While the curve 1302 in FIG. 13A is E[ΔW] over the range between the bounds of k₊, the horizontal line 1304 is the desired E[ΔW]. FIG. 13B illustrates the difference 1312 (i.e., the error) between the curve and the desired value in FIG. 13A, where the minima 1314 represent two possible solutions for k₊.

A Note about STDP Rules

The STDP rules will affect the parameters of the STDP curve through the expected number of LTP and/or LTD updates and the probability distributions of δts.

For example, in the High Level Network Description (HLND) v4.0, when more than one presynaptic spike occurs between two postsynaptic spikes, only the latest presynaptic spike causes an LTP update (see FIGS. 14A-C). When calculating pLTP(δt) from the model (run without plasticity), only presynaptic spikes that occur closest to the postsynaptic spike are counted. This produces a very different probability distribution than if all presynaptic spikes were considered. FIGS. 14A-C show how the probability distribution differs and how this affects the STDP curve parameters.

More specifically, FIG. 14A illustrates two different STDP rules: the top rule 1402 is from non-Hardware Compatible HLND (non-HC-HLND) v4.0 and the bottom rule 1404 is from Hardware Compatible HLND (HC-HLND) v4.0. FIG. 14B is a histogram 1406 of the number of LTD (negative x-axis 1408) and LTP (positive x-axis 1410) events assuming the non-HC-HLND rules 1412 (or the HC-HLND rules 1414). FIG. 14C depicts the STDP curves 1416, 1418 derived from the different distributions of LTD and LTP events. E[ltp] is the expected value of the total amount of LTP, and E[ltd] is the expected value of the total amount of LTD. While the absolute values of the expected LTP and LTD are different between the two sets of rules, the relative value of E[ltp] and E[ltd] are the same for both sets of rules.

### Beta Function as a Universal Representation for LTP

According to certain aspects of the present disclosure, the form of a probability density function (PDF) for a Beta distribution may be used as a universal representation for LTP. This and a related method of determining the shape parameters in the Beta distribution (α, β) are described below.

FIG. 10B illustrates a PDF 1010 for Beta distributions with varied shape parameters (α, β). The PDF f may be expressed as

$$f ( x , α , β ) = \frac{k}{Beta [ α , β ]} {{x}^{α - 1} ( 1 - x )}^{β - 1}$$

If k=1, then this equation is a proper PDF. Here, since a PDF is not strictly being dealt with, one may have any k.

As shown in FIG. 10B, the Beta PDF can yield a range of diverse shapes. One can adjust the “skewness” of the function by manipulating the ratio α/β. In addition, one can also control the width of the PDF by manipulating the variance:

$${var}_{Beta} [ x ] = \frac{αβ}{{( α + β )}^{2} ( α + β + 1 )}$$

The shape of a Beta PDF is a high-degree polynomial function, which can be fully precomputed given α and β.

In designing an STDP curve for plastic synapses, one important question is when the potentiation should take place. Once this window is known, the next question is by how much. In the present disclosure, it is assumed that the window of potentiation is known or can be calculated based on the neuron parameters. The window of potentiation is defined by a range of {Δt=tₚₒₛₜ−tₚᵣₑ}, where tₚₒₛₜ and tₚᵣₑ are the postsynaptic spike time and presynaptic spike time, respectively. Once this range is known, it can be normalized to suit the domain requirement in the Beta distribution (e.g., 0≦x≦1).

As part of an overall spiking design, the present disclosure uses a set of parameters that are predetermined, as described above. For example, these parameters include τ₊ and τ₋ (the time constants for the Cold model), wₘₐₓ (the maximum weight value of the synapse), and wᵢₙᵢₜ (the initial weight value of the synapse).

### Calculation of x in Beta(x; α,β)

In this section, it is assumed that the parameters in the neuron model have been determined. For example, the time constant τ₊ in the Cold model is used to estimate the time it takes to reach vₚₑₐₖ. Using the Cold model as a reference design and given incoming (or presynaptic) spike statistics (i.e., E[Δtₚᵣₑ]), one may wish to determine what is the distribution of v(t) after crossing the threshold v₊, where Δtₚᵣₑ is the inter-event interval for all the presynaptic spikes impinging on a postsynaptic neuron. In addition to estimating E[Δtₚᵣₑ], one may take into account the number of presynaptic spikes (k) that are designed to trigger the artificial neuron. The threshold voltage may then be discounted from the aggregated or net effect of the presynaptic excitation.

First, one may consider a simple case, in which k=2. The voltage in the LIF is determined by

$$v ( {t}_{1} ) = v ( {t}_{0} ) {e}^{\frac{- ( {t}_{1} - {t}_{0} )}{{τ}_{-}}} + {v}_{-}$$

where Δt=t₁−t₀. The voltage increment may be enumerated as follows:

$$v ( {t}_{1} ) = v ( {t}_{0} ) + {w}_{max} {e}^{- \frac{{t}_{1} - {t}_{0}}{{τ}_{-}}} + {w}_{max} \qquad ( 43 )$$

One can ask, what is the expected voltage E[v(t₁)], with Δt=t₁−t₀ being the random variable with P(Δt)? This may be answered by substituting t₁−t₀ with E[Δt]. So setting v₋=v(t₀), one has

$$E [ v ( {t}_{1} ) ] = {v}_{-} + {w}_{max} {e}^{- \frac{E [ Δ t ]}{{τ}_{-}}} + {w}_{max}$$

Now, for k=3, one has

$$v ( {t}_{2} ) = ( {w}_{max} {e}^{- \frac{{t}_{1} - {t}_{0}}{{τ}_{-}}} + {w}_{max} ) {e}^{- \frac{{t}_{2} - {t}_{1}}{{τ}_{-}}} + {w}_{max} + {v}_{-}$$

Then, E[v(t₂)] is

$$E [ v ( {t}_{2} ) ] = ( {w}_{max} {e}^{- \frac{E [ Δ t ]}{{τ}_{-}}} + {w}_{max} ) {e}^{- \frac{E [ Δ t ]}{{τ}_{-}}} + {w}_{max} + {v}_{-}$$

which can be simplified as

$$E [ v ( {t}_{2} ) ] = {w}_{max} {e}^{- \frac{2 E [ Δ t ]}{{τ}_{-}}} + {w}_{max} {e}^{- \frac{E [ Δ t ]}{{τ}_{-}}} + {w}_{max} + {v}_{-} = {w}_{max} {E [ δ ]}^{2} + {w}_{max} E [ δ ] + {w}_{max} + {v}_{-}$$

where v− is the reset voltage in the Cold model and

$$E [ δ ] = E [ {e}^{\frac{- E [ Δ t ]}{{τ}_{-}}} ] .$$

Generalizing this formula for arbitrary k, one obtains

$$\begin{matrix}E [ v ( {t}_{k - 1} ) ] = {w}_{max} {E [ δ ]}^{k - 1} + {w}_{max} {E [ δ ]}^{k - 2} + … + {w}_{max} + {v}_{-} \\ = {v}_{-} + {\sum }_{i = 0}^{k - 1} {w}_{max} {E [ δ ]}^{i} \\ = {v}_{-} + {\sum }_{i = 0}^{k - 1} {w}_{max} {e}^{- \frac{E [ Δ t ] i}{{τ}_{-}}}\end{matrix} \qquad ( 44 )$$

### Modeling P(Δt)

To further investigate the effect of random variable Δt on v(t), P(Δt) may be modeled in closed form. One option is to use an exponential distribution, such as

P(Δt;λ)=λe^{-Δt}

Incorporating this probability density function (PDF) into the generalized equation above and using the fact that the mean of an exponential distribution is λ⁻¹, one has

$$E [ v ( {t}_{k - 1} ) ] = {v}_{-} + {\sum }_{i = 0}^{k - 1} {w}_{max} {e}^{- \frac{i}{{λτ}_{-}}} \qquad ( 45 )$$

One may note that for a predetermined τ₋, the two factors the drive the dynamics of E[v(t)] or E[Δv] are the number of presynaptic spikes k and the rate of incoming spikes λ. If the v₋ and v₊ are designed in such a way, it is highly unlikely for the voltage to surpass v₊ with less than k spikes. Also, one may use the λ dimension to encode different input patterns.

### Modeling x

Now one has a reasonable idea of what the distribution of v(t) will be, given k spikes and that these spikes come in at a P(Δt) interval (modeled as an exponential distribution, for example). One also has a way to estimate the CDF of v(t). Now, the question is whether one wants to choose an

$$x = \frac{Δ {t}_{ALIF}}{{T}_{LTP}}$$

to be conservative with the estimation of v(t), where Δt_{ALIF} indicates the projected time to vₚₑₐₖ given v(t) has crossed v₊ and T_{LTP} is the potentiation window described above.

If conservative with this estimate, one may have a CDF(v(t))>99%, such that v(t) is below this value 99% of the time and it takes longer to reach vₚₑₐₖ in most cases. There is a consequence to this bias, as one can see in a plot of the PDF for a Beta distribution, which can be a heavily positively skewed distribution, depending on α and β. More importantly, the more positively skewed the shape, the faster the drop-off for x<xₚₑₐₖ. As a result, one may wish to be conservative with the CDF(v(t)), in an effort to reduce the number of really small Δt_{ALIF}.

The CDF for an exponential distribution P(Δt) is 1−e^{-λΔt}. So for a CDF of 99%, Δt→4.60517/λ. Substituting into Eq. 44 produces

$$v ( {t}_{k - 1} ) = {v}_{-} + {\sum }_{i = 0}^{k - 1} {w}_{max} {e}^{- \frac{4.6 i}{λ {τ}_{-}}} \qquad ( 46 )$$

One can obtain the following closed-form expression for Eq. 46:

$$v ( {t}_{k - 1} ) = {v}_{-} + \frac{{e}^{\frac{4.6 - 4.6 k}{{λτ}_{-}}} ( {e}^{\frac{4.6 k}{λ {τ}_{-}}} - 1 ) {w}_{max}}{{e}^{\frac{4.6}{{λτ}_{-}}} - 1}$$

For example, plugging v₊=−40, v₋=−55, k=10, wₘₐₓ=5.6, τ₋=13, and λ=10 into the equation above yields −6.99619.

### Determine Shape Parameters

In order to determine the shape parameters for the STDP curve, one may use the criterion that at a desired time instance, the potentiation is a maximum. In other words, the first-order derivative of the PDF for a Beta distribution is equated to zero. The first-order derivative equals

$$\frac{{( 1 - x )}^{- 1 + β} {x}^{- 2 + α} ( - 1 + α )}{Beta [ α , β ]} - \frac{{( 1 - x )}^{- 2 + β} {x}^{- 1 + α} ( - 1 + β )}{Beta [ α , β ]}$$

After temporarily removing the Beta function and simplifying this equation by restricting both α and β to be larger than 1, the solution is

$$x = {x}^{′} = \frac{α - 1}{α + β - 2} \qquad ( 47 )$$

As x′ is the desired relative time instance between 0 and 1, α and β have the following relationship:

$$α -> - \frac{1 + x ( - 2 + β )}{- 1 + x}$$

### Effective Window of Operation

Another feature of the STDP curve, which is captured by certain aspects of the present disclosure, is the effective window of operation. This effective window is different from the window of operation for the LTP, which is normalized to (0,1) (i.e., the x parameter in the Beta PDF). The effective window uses the standard deviation of the PDF to indicate which region in the function is more effective in the LTP activity.

Given a desired amount of variance δ², one can use the following variance function for the Beta distribution:

$${δ}^{2} = \frac{α β}{{( α + β )}^{2} ( α + β + 1 )} \qquad ( 48 )$$

Together with Eq. 47, one can solve for the individual parameters {α,β}.

What all this means is that for a known x=x′, there is a ratio

$$K = \frac{α}{c + β}$$

which may most likely be maintained, so that the PDF will be maximum. For example, with x=0.1,

$$α = \frac{1 - 0.2 + 0.1 β}{0.9} = \frac{0.8 + 0.1 β}{0.9} = \frac{8 + β}{9}$$

### Application to Vision Models

Training with Gratings

FIG. 15 illustrates example grating stimuli used to train the V1 magno pathway, in accordance with certain aspects of the present disclosure. The spatial period is 48 pixels. The training protocol contained 60 frames of the horizontal gratings 1502 at random phases followed by 60 frames of the vertical gratings 1504 at random phases and repeated for as long as the model was trained.

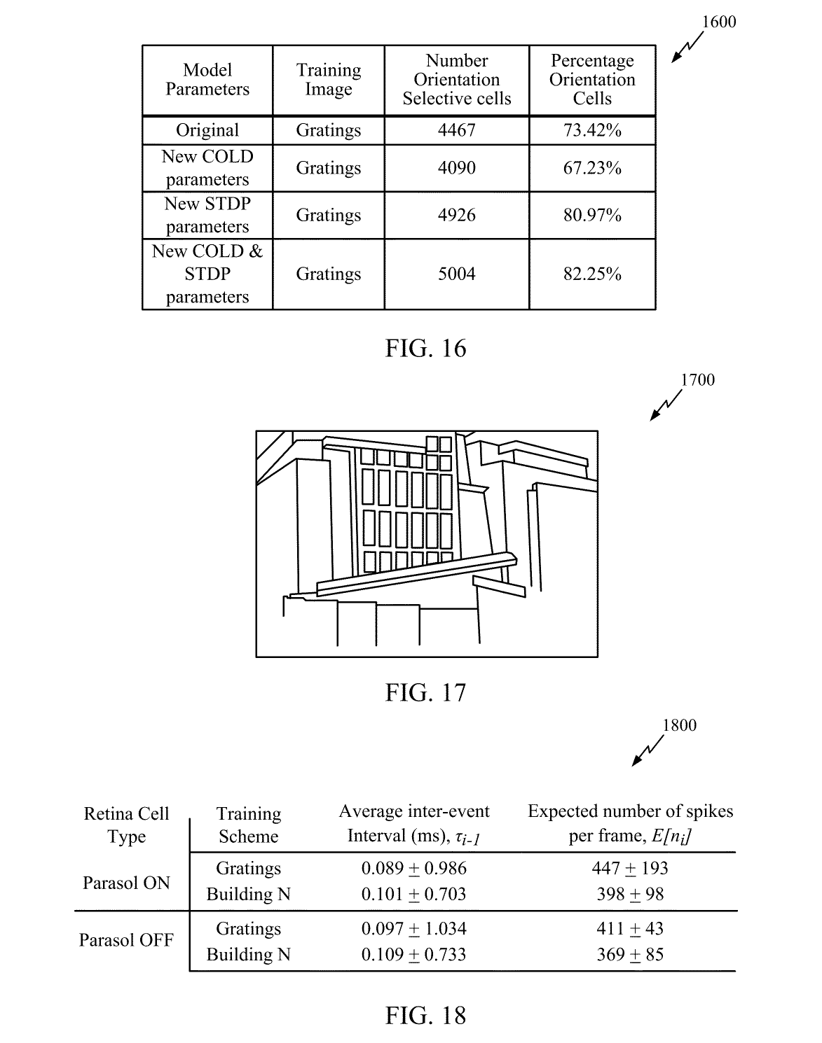

The first test of the methodology was to redesign Layer 4 of the magno pathway during training on the gratings 1502, 1504 of FIG. 15 and reproduce a number of orientation cells. The table 1600 in FIG. 16 shows the measured retinal spiking statistics and the calculated Cold parameters. Using the new Cold parameters produced an initial drop in the number of orientation selective cells as expected since the Cold parameters were changed without changing the STDP curve.

After calculating a new STDP curve (parameters shown in table 2300 of FIG. 23) based on the Cold neuron spiking statistics, a ˜10% increase in the number of orientation selective cells was achieved. Thus, the feature extraction methodology described above was able to out-perform the original model in terms of the number of orientation selective cells.

Training with Building N Image

This section describes the changes made to the magno pathway of the latest Cold model to accommodate training with an image 1700 of Building N on the Qualcomm campus, as shown in FIG. 17, rather than spatial gratings. This section first describes the differences in the model output and training under the two different training schemes and then addresses how the model was changed to improve performance on the Building N training scheme.

Differences Between Training with Gratings and the Building N Image

To determine which parts of the model may most likely be adjusted for the Building N image, the differences in retinal activation under grating training and building training were investigated. Since only the parasol cells of the retina project to the magno layers, only these cells were investigated.

Since the parameters of all of the Cold neurons were determined from the average firing statistics of the retinal parasol cells during grating training, how the average firing statistics changed during the Building N training were investigated. Table 1800 of FIG. 18 shows the relevant parameters calculated from the retina activity during grating training and building training

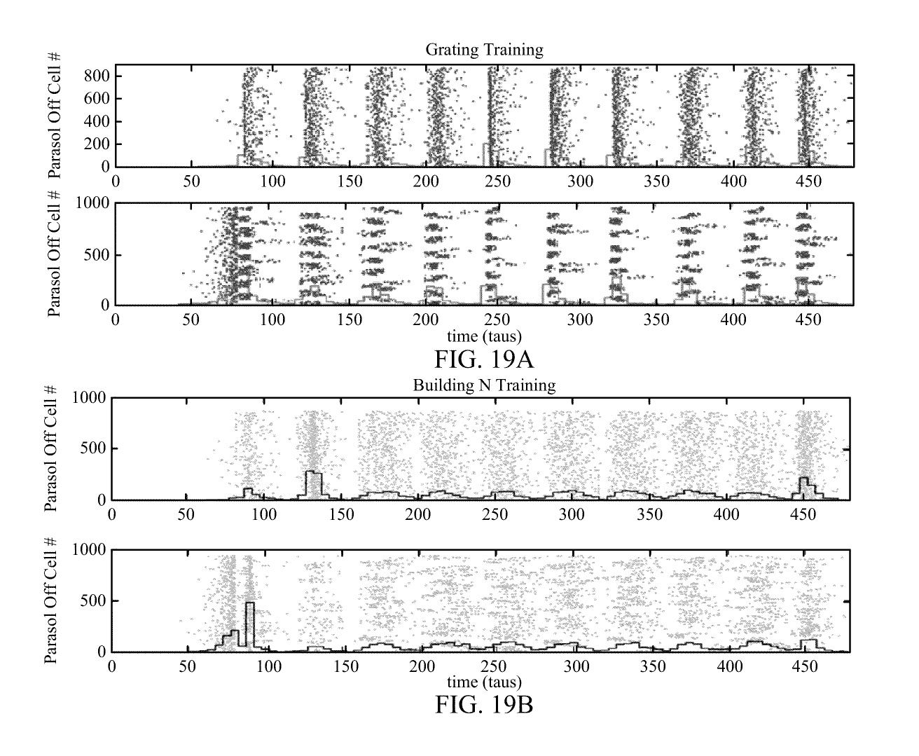

FIGS. 19A and 19B illustrate parasol cell spiking during grating and building training for comparison, in accordance with certain aspects of the present disclosure. The two raster plots in FIG. 19A show the spikes from parasol off (top) and on (bottom) cells during the first 10 images of the grating training. Cycles of spikes repeat every 40 ms with the change in the frame. The line at the bottom is the number of spikes per 5 tau bin (number is indicated on left axis), where tau is the step size in the discrete artificial nervous system. The two raster plots in FIG. 19B show the same for the first 10 images of the Building N training. The large burst of spikes near 450 tau is due to a “macrosaccade” away from the area being presented through “microsaccades” up to that point.

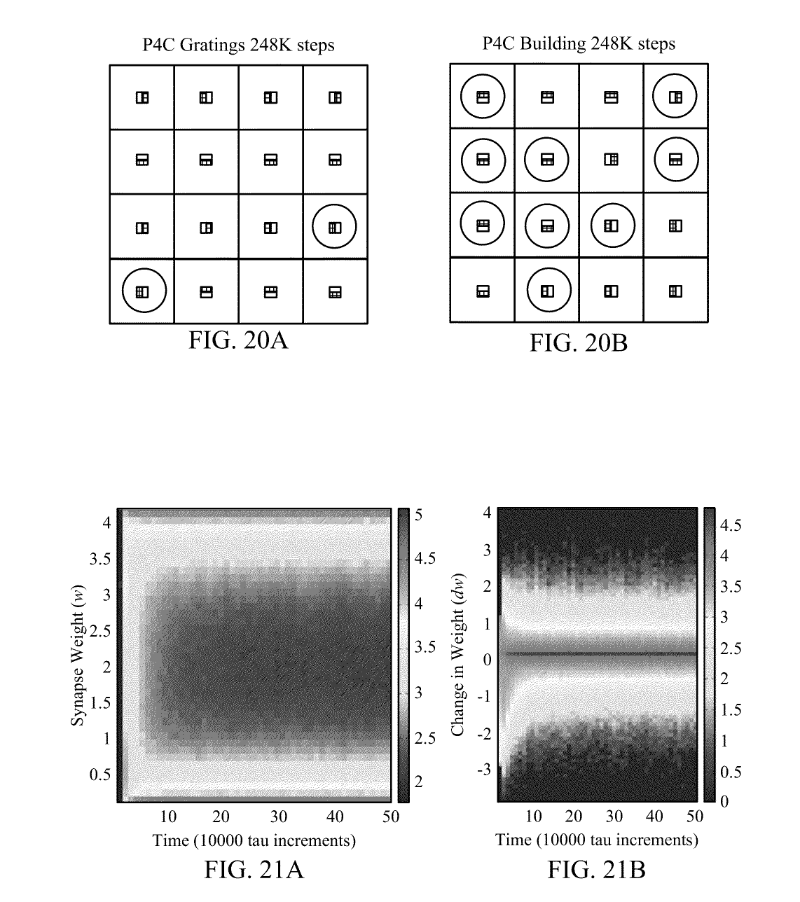

How the emergent receptive fields in the magno layer 4 cells changed when trained on gratings versus the Building N image was also investigated. FIGS. 20A and 20B show the receptive fields, calculated with a spike triggered average (STA) analysis, after both types of training. There are more gabor-like receptive fields when trained with gratings. The grid shows the middle 16 (4×4) cell receptive fields in the magno layer 4 population. Each simulation was run for 1.2 million taus with plasticity on between the retinal ganglion cells and the layer 4 magno units for 248,000 taus. Non-gabor-like receptive fields are circled.

However, the random nature of the saccades around the Building N image could mean that the requisite number of orientations takes longer to be presented, which could indicate a longer training time. To determine if a longer training time is desired, how long it took for the weights to converge was investigated. The Building N training was run for 5 million taus, and the weights of all synapses from the retina parasol cell to magno excitatory layer 4 cells were recorded. The weights are considered to have converged when they no longer change from one tau to the next.

FIGS. 21A and 21B illustrate that the distribution of weights was relatively stable by 250,000 taus, meaning that an increase in training time did not affect convergence. FIG. 21A shows the distribution of synapse weights at each recorded tau, which were 10,000 taus apart. All of the weights were initialized to 3 (as can be seen in the first column of the FIG. 21A). The grayscale is log₁₀ of the number of synapses with a given weight (binned in 0.1 wide bins). By ˜250,000 taus, the distribution is fairly stable. FIG. 21B illustrates the distribution of the changes in weight (or dw) between each recorded tau. The grayscale is base log₁₀ of the number of synapses with a given dw, again in 0.1 wide bins. As for the actual weights, the distribution of weight changes is fairly stable by ˜250,000 taus.

Redesign of the Magno Layer 4 Pathway to Train with Building N Image

Applying the method described above to the vision model, the known STDP constants were set to the values indicated in the rows of table 2300 of FIG. 23. Other STDP parameters were calculated to be those indicated in the last rows of table 2300.

As shown in FIG. 5, the first step in designing a network to learn a particular set of features is to decide what those features are. For example, as discussed above, a design decision was made to extract gabor-like features with a spatial frequency of 48 pixels/cycle. To capture this frequency, the magno layer 4 cells have circular receptive fields with a diameter equal to or greater than 48 pixels.

From the topology of the retina, it was calculated that approximately 10 retinal parasol cells may most likely project to each magno layer 4 cell to achieve a receptive field diameter greater than 48 pixels. Since there are two classes of parasol cells (on-cells and off-cells), which are roughly co-located, nfanin may be defined to equal 19 (it is not twenty since the cells are not exactly collocated). It was also calculated that on average, 2.5 presynaptic neurons are different between adjacent layer 4 cells, meaning there is an 86.9% overlap in the presynaptic receptive fields.

To design the Cold neuron parameters, the retina model was run for 40,000 taus, and the parasol spikes were recorded. The resulting Cold parameters are shown in table 2300.

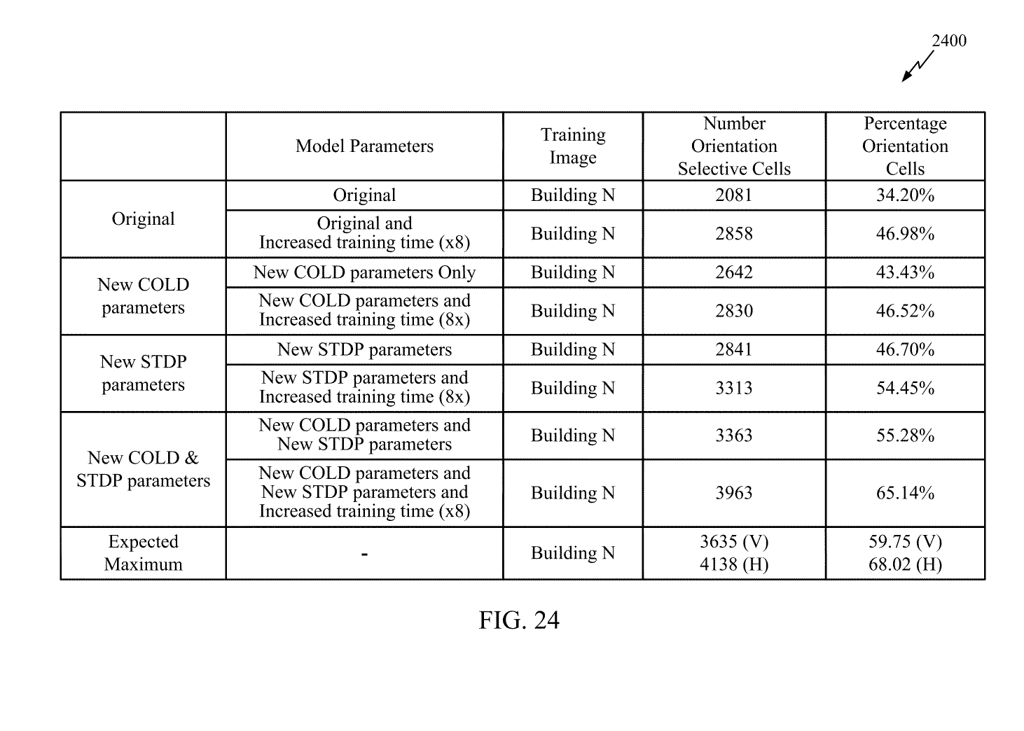

The rows labeled “New COLD parameters” in table 2400 of FIG. 24 show that changing the Cold neuron parameters alone caused an increase in performance for the original training time (248 k taus). However, at longer training times (1,984 k taus), there was a slight drop in performance. This is due to the fact that the neuron parameters are being changed, which changes the probability of post-pre times, without changing the STDP curve. By changing both (rows labeled “New COLD & STDP parameters” of table 2400), much better performance can be achieved.

For the layer 4 STDP design, the expected number of features and the expected gap between similar features were determined by assuming a gabor feature with a spatial frequency of 48 pixels/cycle and an orientation of 0/180, 45, 90, or 135°. This spatial frequency was chosen to be the same as the grating spatial frequency.

Gabor filters at each of the four orientations were convolved for a patch of the Building N image to produce four feature maps whose pixel values were the absolute value of the result of the gabor convolution for each of the orientations. The sum of all of the pixel values in each feature map within a region corresponding to each layer 4 neuron's receptive field was then taken. This produced four numbers for each layer 4 neuron indicating the magnitude of the image response to a gabor filter at each orientation. The maximum of these four numbers was used to determine which of the four orientations was best represented in that neuron's receptive field. If the maximum was below a value of 100 (determined experimentally), then no feature was represented in that neuron's receptive field. By repeating this process for the first 1000 Building N patches shown during training, E[nf] and E[nnf] can be computed.

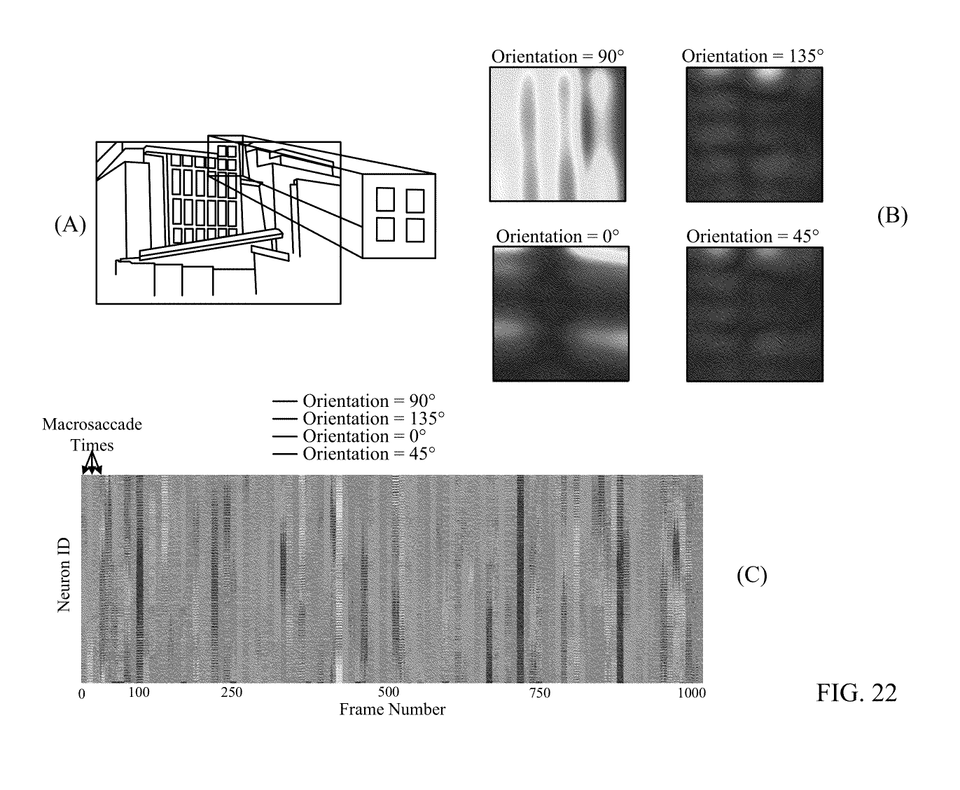

FIGS. 22A-C show a schematic of this process and the resulting distribution of features. FIG. 22A shows a particular patch from the Building N image (from frame 1000). FIG. 22B depicts the feature maps calculated by convolving gabor filters with a spatial period of 48 pixels and the indicated orientations. Since this patch has predominantly vertical edges, the feature power for the 90° orientation is the highest for most locations in the patch. The grayscale is from 0 to 500. FIG. 22C shows the strongest feature in each layer 4 neuron's receptive field (scaled according to the legend). The vertical striations are generated because of the training protocol, which presents a jittered version of each patch for 10 frames before moving to a very different location. The example patch from FIG. 22A is taken from the last column of this plot. Consistent with the feature maps, the predominant feature for all neurons during this patch presentation is a vertical edge.

Because of the stroboscopic retina, one could easily set T equal to 40 ms, the frame rate. Also, since this simulation was occurring in HLND v4.02 with non-HC compliant synapse rules, the STDP update assumptions were set accordingly. The resulting STDP curve parameters are shown in table 2300, and a graph of the curve is shown in FIG. 14C.

Table 2400 shows that changing the STDP curve alone increased performance more than changing the Cold neuron parameters alone. The best performance was achieved, though, when both the Cold parameters and the STDP parameters were designed according to the method described above.

Moreover, the performance with redesigned Cold and STDP parameters reached the expected maximum number of orientation receptive fields calculated from the image. This expected maximum was calculated by using the gabor filtered images described above. How many cells had seen a relevant feature for the previous E[n_{f}] consecutive frames at each frame-step was calculated. The average over each frame-step was taken to get a measure of the average number of frames that should have learned a relevant feature at any point in the training. These expected maximums are shown for horizontal and vertical orientations in table 2400.

### Example Operation of an Artificial Nervous System

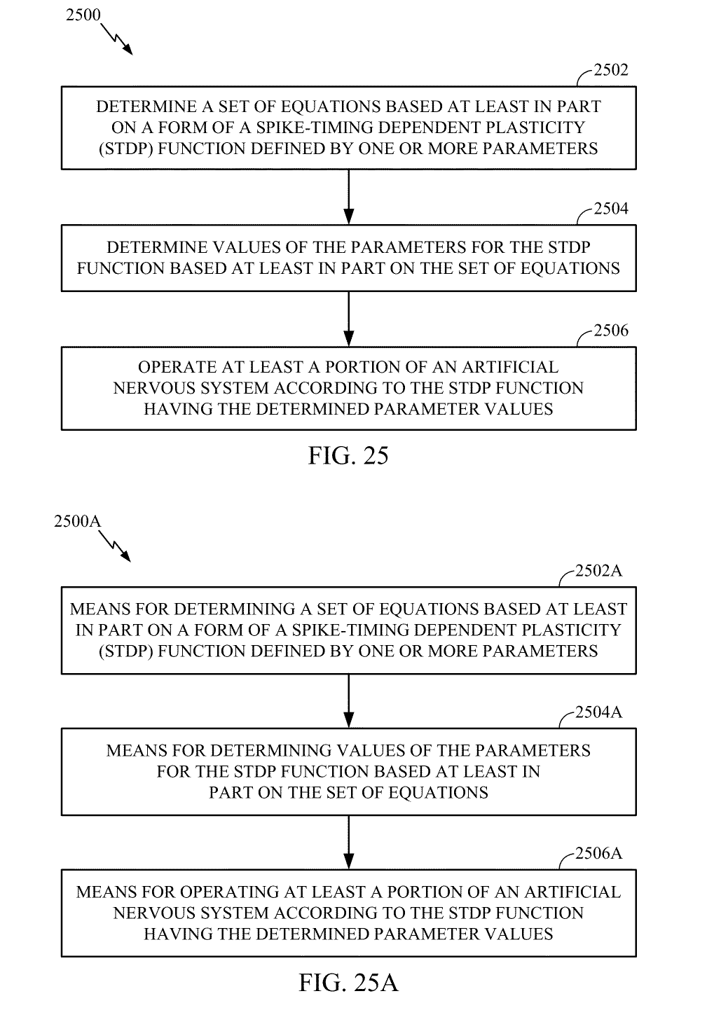

FIG. 25 is a flow diagram of example operations 2500 for operating an artificial nervous system, in accordance with certain aspects of the present disclosure. The operations 2500 may be performed in hardware (e.g., by one or more neural processing units, such as a neuromorphic processor), in software, or in firmware. The artificial nervous system may be modeled on a visual nervous system, for example.

The operations 2500 may begin, at 2502, by determining a set of equations based at least in part on a form of an STDP function defined by one or more parameters. At 2504, values of the parameters for the STDP function may be precisely determined based, at least in part, on the set of equations. At 2506, at least a portion of the artificial nervous system may be operated according to the STDP function having the determined parameter values. For certain aspects, the operation at 2506 may include learning a relationship between a pattern input to the at least the portion of the artificial nervous system and a pattern output by the at least the portion of the artificial nervous system.

According to certain aspects, the form of the STDP function is a double exponential function. In this case, the double exponential STDP function may have 6 parameters including 2 offsets, 2 amplitudes, and 2 time constants, and the set of equations includes 6 equations.

For certain aspects, the set of equations is based on one or more constraints. The constraints may be based, at least in part, on at least one of desired asymptotic behavior, desired typical behavior, a limiting behavior for potentiation, or a limiting behavior for depression.

According to certain aspects, the artificial nervous system is composed of a network of artificial neurons connected by synapses. The operation at 2506 may include adjusting weights of the synapses based on the STDP function. For certain aspects, a neuron model for determining states of the artificial neurons includes a time-to-spike variable. For example, the neuron model may be a Hunzinger Cold model. The operations 2500 (especially determination of the parameter values) may be independent of the neuron model.

According to certain aspects, the form of the STDP function includes one or more polynomial functions. In this case, the one or more polynomial functions may be parameterized by at least two exponents within a normalized domain and may be solved by enforcing a global maximum and a predetermined standard deviation.

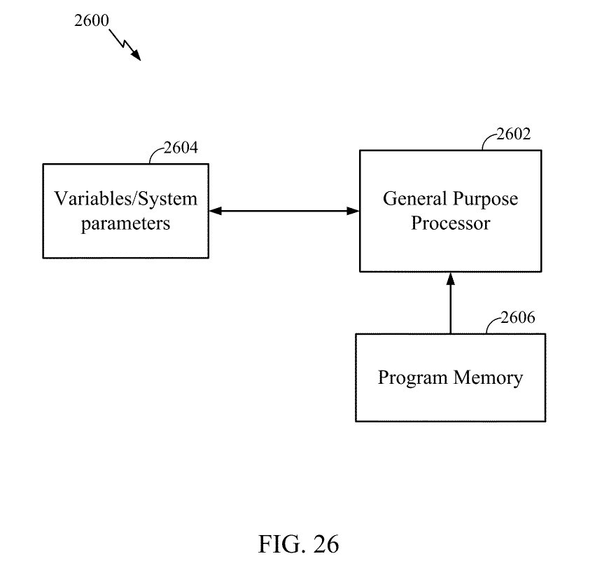

FIG. 26 illustrates an example block diagram 2600 of an implementation for operating an artificial nervous system using a general-purpose processor 2602 in accordance with certain aspects of the present disclosure. Variables (neural signals), synaptic weights, and/or system parameters associated with a computational network (neural network) may be stored in a memory block 2604, while instructions related executed at the general-purpose processor 2602 may be loaded from a program memory 2606. In an aspect of the present disclosure, the instructions loaded into the general-purpose processor 2602 may comprise code for determining a set of equations based at least in part on a form of an STDP function defined by one or more parameters, code for determining values of the parameters for the STDP function based at least in part on the set of equations, and code for operating at least a portion of the artificial nervous system according to the STDP function having the determined parameter values.

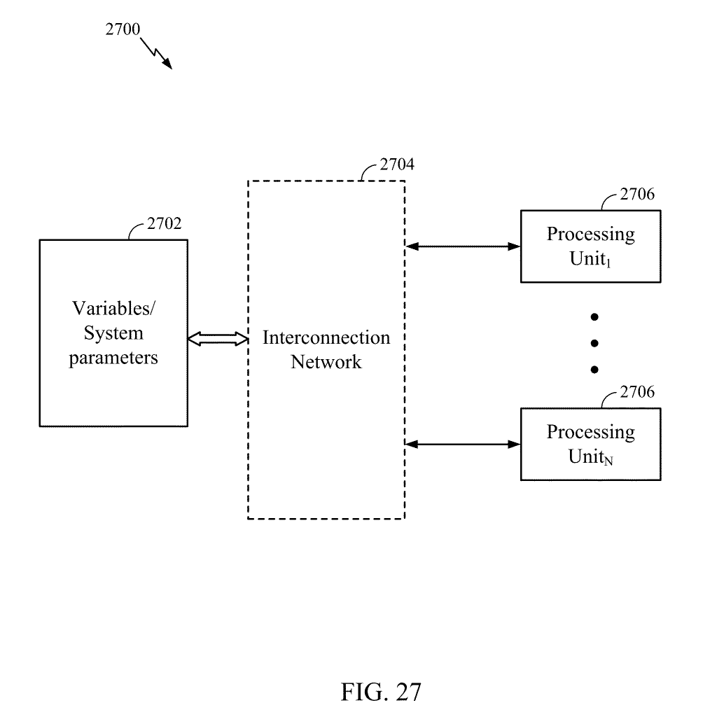

FIG. 27 illustrates an example block diagram 2700 of an implementation for operating an artificial nervous system where a memory 2702 can be interfaced via an interconnection network 2704 with individual (distributed) processing units (neural processors) 2706 of a computational network (neural network) in accordance with certain aspects of the present disclosure. Variables (neural signals), synaptic weights, and/or system parameters associated with the computational network (neural network) may be stored in the memory 2702, and may be loaded from the memory 2702 via connection(s) of the interconnection network 2704 into each processing unit (neural processor) 2706. In an aspect of the present disclosure, the processing unit 2706 may be configured to determine a set of equations based at least in part on a form of an STDP function defined by one or more parameters, to determine values of the parameters for the STDP function based at least in part on the set of equations, and to operate at least a portion of the artificial nervous system according to the STDP function having the determined parameter values.

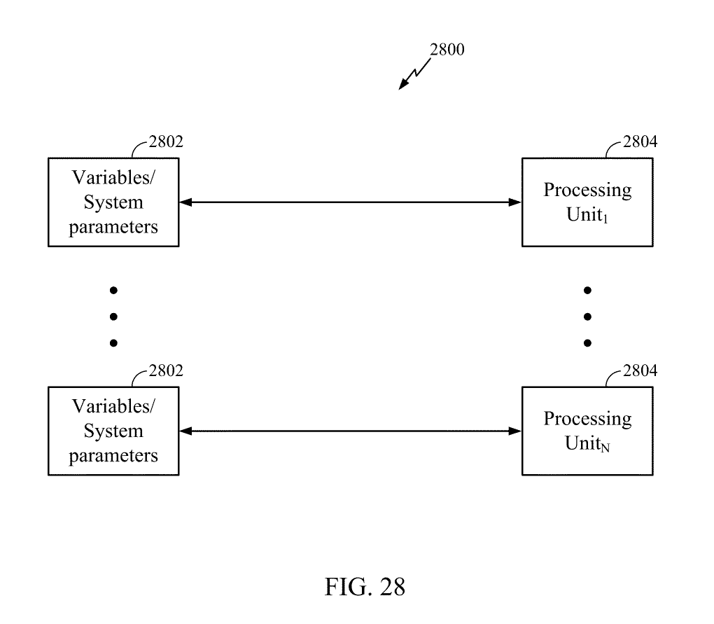

FIG. 28 illustrates an example block diagram 2800 of an implementation for operating an artificial nervous system based on distributed weight memories 2802 and distributed processing units (neural processors) 2804 in accordance with certain aspects of the present disclosure. As illustrated in FIG. 28, one memory bank 2802 may be directly interfaced with one processing unit 2804 of a computational network (neural network), wherein that memory bank 2802 may store variables (neural signals), synaptic weights, and/or system parameters associated with that processing unit (neural processor) 2804. In an aspect of the present disclosure, the processing unit(s) 2804 may be configured to determine a set of equations based at least in part on a form of an STDP function defined by one or more parameters, to determine values of the parameters for the STDP function based at least in part on the set of equations, and to operate at least a portion of the artificial nervous system according to the STDP function having the determined parameter values.

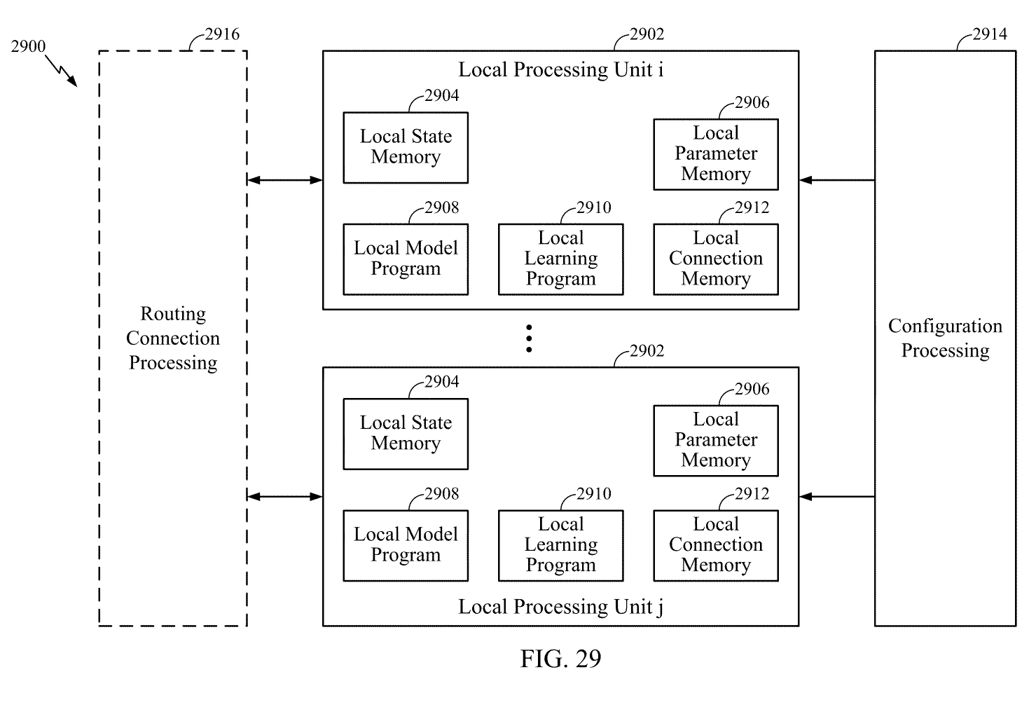

FIG. 29 illustrates an example implementation of a neural network 2900 in accordance with certain aspects of the present disclosure. As illustrated in FIG. 29, the neural network 2900 may comprise a plurality of local processing units 2902 that may perform various operations of methods described above. Each processing unit 2902 may comprise a local state memory 2904 and a local parameter memory 2906 that store parameters of the neural network. In addition, the processing unit 2902 may comprise a memory 2908 with a local (neuron) model program, a memory 2910 with a local learning program, and a local connection memory 2912. Furthermore, as illustrated in FIG. 29, each local processing unit 2902 may be interfaced with a unit 2914 for configuration processing that may provide configuration for local memories of the local processing unit, and with routing connection processing elements 2916 that provide routing between the local processing units 2902.

According to certain aspects of the present disclosure, each local processing unit 2902 may be configured to determine parameters of the neural network based upon desired one or more functional features of the neural network, and develop the one or more functional features towards the desired functional features as the determined parameters are further adapted, tuned and updated.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, the various operations may be performed by one or more of the various processors shown in FIGS. 26-29. Generally, where there are operations illustrated in figures, those operations may have corresponding counterpart means-plus-function components with similar numbering. For example, operations 2500 illustrated in FIG. 25 correspond to means 2500A illustrated in FIG. 25A.

For example, means for displaying may comprise a display (e.g., a monitor, flat screen, touch screen, and the like), a printer, or any other suitable means for outputting data for visual depiction (e.g., a table, chart, or graph). The means for processing, means for operating, means for calculating, means for computing, or means for determining may comprise a processing system, which may include one or more processors or processing units. Means for storing may comprise a memory or any other suitable storage device (e.g., RAM), which may be accessed by the processing system.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of a, b, or c” is intended to cover a, b, c, a-b, a-c, b-c, and a-b-c.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of operating an artificial nervous system, comprising:
determining a set of equations based at least in part on a form of a spike-timing dependent plasticity (STDP) function defined by one or more parameters;
determining values of the parameters for the STDP function based at least in part on the set of equations; and
operating at least a portion of the artificial nervous system according to the STDP function having the determined parameter values.

2. The method of claim 1, wherein the operating comprises learning a relationship between a pattern input to the at least the portion of the artificial nervous system and a pattern output by the at least the portion of the artificial nervous system.

3. The method of claim 1, wherein the form of the STDP function is a double exponential function.

4. The method of claim 3, wherein the double exponential STDP function has 6 parameters including 2 offsets, 2 amplitudes, and 2 time constants.

5. The method of claim 4, wherein the set of equations comprises 6 equations.

6. The method of claim 1, wherein the set of equations are based on one or more constraints.

7. The method of claim 6, wherein the constraints are based at least in part on at least one of desired asymptotic behavior, desired typical behavior, a limiting behavior for potentiation, or a limiting behavior for depression.

8. The method of claim 1, wherein the artificial nervous system is modeled on a visual nervous system.

9. The method of claim 1, wherein the artificial nervous system comprises a network of artificial neurons connected by synapses.

10. The method of claim 9, wherein the operating comprises adjusting weights of the synapses based on the STDP function.

11. The method of claim 9, wherein a neuron model for determining states of the artificial neurons comprises a time-to-spike variable.

12. The method of claim 11, wherein the neuron model comprises a Hunzinger Cold model.

13. The method of claim 11, wherein the method is independent of the neuron model.

14. The method of claim 1, wherein the form of the STDP function comprises one or more polynomial functions.

15. The method of claim 14, wherein the one or more polynomial functions are parameterized by at least two exponents within a normalized domain and are solved by enforcing a global maximum and a predetermined standard deviation.

16. An apparatus for operating an artificial nervous system, comprising:
a processing system configured to:
determine a set of equations based at least in part on a form of a spike-timing dependent plasticity (STDP) function defined by one or more parameters;
determine values of the parameters for the STDP function based at least in part on the set of equations; and
operate at least a portion of the artificial nervous system according to the STDP function having the determined parameter values; and
a memory coupled to the processing system.

17. The apparatus of claim 16, wherein the processing system is configured to operate by learning a relationship between a pattern input to the at least the portion of the artificial nervous system and a pattern output by the at least the portion of the artificial nervous system.

18. The apparatus of claim 16, wherein the form of the STDP function is a double exponential function.

19. The apparatus of claim 18, wherein the double exponential STDP function has 6 parameters including 2 offsets, 2 amplitudes, and 2 time constants.

20. The apparatus of claim 19, wherein the set of equations comprises 6 equations.

21. The apparatus of claim 16, wherein the set of equations are based on one or more constraints.

22. The apparatus of claim 21, wherein the constraints are based at least in part on at least one of desired asymptotic behavior, desired typical behavior, a limiting behavior for potentiation, or a limiting behavior for depression.

23. The apparatus of claim 16, wherein the artificial nervous system is modeled on a visual nervous system.

24. The apparatus of claim 16, wherein the artificial nervous system comprises a network of artificial neurons connected by synapses.

25. The apparatus of claim 24, wherein the processing system is configured to operate by adjusting weights of the synapses based on the STDP function.

26. The apparatus of claim 24, wherein a neuron model for determining states of the artificial neurons comprises a time-to-spike variable.

27. The apparatus of claim 26, wherein the neuron model comprises a Hunzinger Cold model.

28. The apparatus of claim 26, wherein the determination of the parameter values is independent of the neuron model.

29. The apparatus of claim 16, wherein the form of the STDP function comprises one or more polynomial functions.

30. The apparatus of claim 29, wherein the one or more polynomial functions are parameterized by at least two exponents within a normalized domain and are solved by enforcing a global maximum and a predetermined standard deviation.

31. An apparatus for operating an artificial nervous system, comprising:
means for determining a set of equations based at least in part on a form of a spike-timing dependent plasticity (STDP) function defined by one or more parameters;
means for determining values of the parameters for the STDP function based at least in part on the set of equations; and
means for operating at least a portion of the artificial nervous system according to the STDP function having the determined parameter values.

32. The apparatus of claim 31, wherein the means for operating is configured to learn a relationship between a pattern input to the at least the portion of the artificial nervous system and a pattern output by the at least the portion of the artificial nervous system.

33. The apparatus of claim 31, wherein the form of the STDP function is a double exponential function.

34. The apparatus of claim 33, wherein the double exponential STDP function has 6 parameters including 2 offsets, 2 amplitudes, and 2 time constants.

35. The apparatus of claim 34, wherein the set of equations comprises 6 equations.

36. The apparatus of claim 31, wherein the set of equations are based on one or more constraints.

37. The apparatus of claim 36, wherein the constraints are based at least in part on at least one of desired asymptotic behavior, desired typical behavior, a limiting behavior for potentiation, or a limiting behavior for depression.

38. The apparatus of claim 31, wherein the artificial nervous system is modeled on a visual nervous system.

39. The apparatus of claim 31, wherein the artificial nervous system comprises a network of artificial neurons connected by synapses.

40. The apparatus of claim 39, wherein the means for operating is configured to adjust weights of the synapses based on the STDP function.

41. The apparatus of claim 39, wherein a neuron model for determining states of the artificial neurons comprises a time-to-spike variable.

42. The apparatus of claim 41, wherein the neuron model comprises a Hunzinger Cold model.

43. The apparatus of claim 41, wherein the determination of the parameter values is independent of the neuron model.

44. The apparatus of claim 31, wherein the form of the STDP function comprises one or more polynomial functions.

45. The apparatus of claim 44, wherein the one or more polynomial functions are parameterized by at least two exponents within a normalized domain and are solved by enforcing a global maximum and a predetermined standard deviation.

46. A computer program product for operating an artificial nervous system, comprising a computer-readable medium having instructions executable to:
determine a set of equations based at least in part on a form of a spike-timing dependent plasticity (STDP) function defined by one or more parameters;
determine values of the parameters for the STDP function based at least in part on the set of equations; and
operate at least a portion of the artificial nervous system according to the STDP function having the determined parameter values.

47. The computer program product of claim 46, wherein the operating comprises learning a relationship between a pattern input to the at least the portion of the artificial nervous system and a pattern output by the at least the portion of the artificial nervous system.

48. The computer program product of claim 46, wherein the form of the STDP function is a double exponential function.

49. The computer program product of claim 48, wherein the double exponential STDP function has 6 parameters including 2 offsets, 2 amplitudes, and 2 time constants.

50. The computer program product of claim 49, wherein the set of equations comprises 6 equations.

51. The computer program product of claim 46, wherein the set of equations are based on one or more constraints.

52. The computer program product of claim 51, wherein the constraints are based at least in part on at least one of desired asymptotic behavior, desired typical behavior, a limiting behavior for potentiation, or a limiting behavior for depression.

53. The computer program product of claim 46, wherein the artificial nervous system is modeled on a visual nervous system.

54. The computer program product of claim 46, wherein the artificial nervous system comprises a network of artificial neurons connected by synapses.

55. The computer program product of claim 54, wherein the operating comprises adjusting weights of the synapses based on the STDP function.

56. The computer program product of claim 54, wherein a neuron model for determining states of the artificial neurons comprises a time-to-spike variable.

57. The computer program product of claim 56, wherein the neuron model comprises a Hunzinger Cold model.

58. The computer program product of claim 56, wherein the method is independent of the neuron model.

59. The computer program product of claim 46, wherein the form of the STDP function comprises one or more polynomial functions.

60. The computer program product of claim 59, wherein the one or more polynomial functions are parameterized by at least two exponents within a normalized domain and are solved by enforcing a global maximum and a predetermined standard deviation.
